(19) United States
(12) Patent Application Publication
(10) Pub. No.: US 2016/0120369 A1
(43) Pub. Date: May 5, 2016

(54) Kitchen appliance comprising positioning device

(71) Applicant: Vorwerk & Co. Interholding GmbH, Wuppertal (DE)

(72) Inventors: Juergen ZILS, Burscheid (DE); Velina VAN DER GAAG, Wuppertal (DE); Barbara DEGEN BRAUN, Wuppertal (DE)

(73) Assignee: Vorwerk & Co. Interholding GmbH, Wuppertal (DE)

(21) Appl. No.: 14/926,324

(22) Filed: Oct. 29, 2015

(30) Foreign Application Priority Data
Oct. 30, 2014 (DE) 10 2014 115 787.7

(51) Int. Cl. A47J 43/07

(52) U.S. Cl. CPC A47J 43/0722

(57) ABSTRACT

The invention relates to a kitchen appliance (1), in particular a mixer, comprising a housing (2), on which a vessel (3) can be arranged, wherein the housing (2) has a vessel receiving area (4), into which the vessel (3) can be inserted, wherein the vessel receiving area (4) is embodied so as to correspond to the shape of the vessel (3) at least in a partial area in such a manner that the vessel (3) can be oriented with regard to a vertical direction as well as with regard to a circumferential direction of the vessel (3) in the course of the insertion into the vessel receiving area (4). With regard to a comfortable use, among others, it is proposed for the vessel receiving area (4) to be substantially embodied as a cylinder, the cylinder jacket of which has a jacket recess (6), so that the cylinder is embodied so as to be substantially open on one side in circumferential direction, wherein a closing device (7), which has at least one pivotable wing (8) or at least one sliding element, which can be shifted in circumferential direction, is arranged on the housing (2), wherein the pivotable wing (8) can be pivoted into the jacket recess (6) so as to correspond to the shape thereof, or wherein the sliding element (11) can be slid into the jacket recess (6) so as to correspond to the shape thereof.

The invention relates to a kitchen appliance, in particular a mixer, comprising a housing, on which a vessel can be arranged, wherein the housing has a vessel receiving area, into which the vessel can be inserted, wherein the vessel receiving area is embodied so as to correspond to the shape of the vessel at least in a partial area in such a manner that the vessel can be oriented with regard to a vertical direction as well as with regard to a circumferential direction of the vessel in the course of the insertion into the vessel receiving area.

Kitchen appliances of the type in question are known. They have a removable vessel, for example, in which a mixing unit for preparing food is arranged, for example. The latter is driven via an electric motor on the kitchen appliance side, for the purpose of which the vessel receiving area and the vessel have corresponding coupling elements. In addition, it is known to provide a heating device for the vessel. For this purpose, the bottom of the vessel has an electrically controllable heating element, for example. In addition, provision can also be made on the vessel for electric measuring devices for measuring a temperature, a pressure or the like.

The vessel can be closed by means of a lid. In addition, the kitchen appliance can have a locking device, which comprises locking rollers, for example, which engage with the lid, for locking the vessel by means of the lid.

To orient the vessel relative to the housing in such a manner that it is possible to lock the vessel by means of the lid or in such a manner that the electric contacts of the vessel contact the electric contacts of the vessel receiving area, it is known in the prior art to embody the housing of the kitchen appliance in such a manner that the shape of the housing supports a user of the kitchen appliance in bringing the vessel into the position required for an electric contacting. Publication WO 2003/075727 A1, for example, discloses a special geometric shape of the housing of the kitchen appliance, which partially encompasses the mixing vessel circumferentially. As a result of the interaction of the housing shape and the weight of the vessel, the vessel is rotated in such a manner in response to an insertion into the vessel receiving area that said vessel assumes a certain position inside the vessel receiving area.

Based on the afore-mentioned prior art, it is the object of the invention to further develop a kitchen appliance of this type, in particular with regard to a comfortable use.

To solve the afore-mentioned object, the invention proposes for the vessel receiving area to be substantially embodied as a cylinder, the cylinder jacket of which has a jacket recess, so that the cylinder is embodied so as to be substantially open on one side in circumferential direction, wherein a closing device, which has at least one pivotable wing or at least one sliding element, which can be shifted in circumferential direction, is arranged on the housing, wherein the pivotable wing can be pivoted into the jacket recess so as to correspond to the shape thereof, or wherein the sliding element can be slid into the jacket recess so as to correspond to the shape thereof.

According to the invention, the housing of the kitchen appliance, in particular the vessel receiving area, is embodied in the shape of a cylinder, wherein the cylinder jacket has a jacket recess substantially across half of the circumference thereof, which can be used to insert the vessel comfortably into the vessel receiving area from a horizontal position. The user of the kitchen appliance thus does not need to lift the vessel over the kitchen appliance any longer and insert the vessel into the vessel receiving area from the top. In combination with the closing device, which closes the jacket recess, it is possible to completely close the vessel receiving area in circumferential direction, so that the vessel is completely surrounded by the vessel receiving area, at least in circumferential direction, and is thus soundproof against the environment. Provision can advantageously also be made thereby for the cylinder to have a closed front side, so that the soundproofing is additionally improved. The closing of the jacket recess takes place in a particularly user-friendly manner by means of pivoting one or a plurality of wings into the jacket recess or by means of inserting one or a plurality of sliding elements into the jacket recess. As a result of the use of pivotable wings or shiftable sliding elements, the user can close the jacket recess with ordinary hand movements, which he knows from door wings or sliding doors, for example. The kitchen appliance can be utilized in a particularly intuitive manner in this respect.

It is proposed for the closing device to have a wing, which can be pivoted about a vertical axis of rotation, or two wings, which can in each case be pivoted about a vertical axis of rotation. The jacket recess can thus be closed by means of only one wing or also by means of two wings, which—as is known from front doors, for example—can be pivoted about a vertical axis of rotation.

With regard to a state of the wing, in which it is pivoted into the jacket recess, provision is made for a gap to be embodied between the wing and the vessel receiving area or between two wings, in which gap a partial area, in particular a hand grip element of the vessel, can be arranged. According to the invention, the wing or the wings are thus embodied in such a manner that they do not completely close the jacket recess in the closed state, but form a gap, in which a partial area of the vessel can be arranged. The partial area of the vessel engages with this gap, so that the jacket recess is not only closed by the wings, but also by the partial area of the vessel. The partial area of the vessel can in particular be a hand grip element, which is arranged on the vessel so as to be oriented radially outwards in any event. This embodiment according to the invention is thereby based on the idea that the partial area of the vessel engages with a pitch circle path, which is provided by the cylinder circumference, and can thus be used to partially close the jacket recess. At the same time, this makes it possible to position the vessel inside the vessel receiving area, because the partial area of the vessel, that is, the hand grip element, for example, protrudes into the jacket recess, which the wing attempts to close. In response to a pivoting of the wing into the jacket recess, the wing is displaced in the area of the pitch circle path and thereby comes into contact with the partial area of the vessel, which protrudes into the pitch circle path. The vessel can thus be displaced into a desired position and can be locked there. The partial area of the vessel glides along the inside of the wing, until the wing assumes its end position and the hand grip element engages with the gap formed between the wing and the vessel receiving area or between two wings.

With regard to an embodiment comprising one or a plurality of sliding elements it is furthermore proposed with regard to a state of the sliding element, in which it is slid into the jacket recess, for a gap to be embodied between the sliding element and the vessel receiving area or between two sliding elements, in which gap a partial area, in particular a hand grip element of the vessel, can be arranged.

As an alternative to the afore-mentioned embodiments, it is proposed for the closing device to have a wing, which can be pivoted about a horizontal axis of rotation. The jacket recess is thereby closed in the manner of a dishwasher or oven door.

Provision is made for the wing, which can be pivoted about a horizontal axis of rotation, to have a recess, in which a partial area, in particular a hand grip element, of the vessel can be arranged. The recess can thereby be embodied in the manner of a gap or in the manner of a groove, so that the partial area of the vessel does not completely permeate the wing. Due to the fact that the wing is also part of the cylinder jacket in this case, the inside of the wing is advantageously embodied so as to be concave and serves as sliding surface for the partial area (hand grip element) of the vessel. In response to a pivoting of the wing in the direction of the jacket recess, the partial area of the vessel glides along the inner wall of the wing, until the partial area of the vessel engages with the recess. In this position, the wing is located in the jacket recess so as to correspond to the shape thereof and serves for soundproofing as well as for orienting the vessel relative to the vessel receiving area, for example so as to be able to lock the vessel by means of the lid.

In combination with each of the afore-mentioned embodiment alternatives, provision can be made for the closing device to be in operative connection with a lifting device or to have a lifting device, which is embodied to lift a vessel, which is inserted into the vessel receiving area, in response to the actuation of the closing device opposite an insertion direction and/or to lower a vessel, which is to be inserted into the vessel receiving area, in insertion direction.

The lifting device supports the user of the kitchen appliance in inserting or removing the vessel into or from the vessel receiving area, respectively. Provision is thereby made for a lifting or lowering, respectively, of the vessel to take place simultaneously with the actuation of the closing device, that is, the pivoting of a wing or the shifting of a sliding element. The lifting device can thereby be a part of the closing device or the lifting device can be in operative connection with the closing device, wherein a partial area of the lifting device acts on a partial area of the closing device. In the former case, the lifting device and the closing device can be embodied in one piece. It is not necessary for the user of the kitchen appliance to carry out a separate hand movement for actuating the lifting device. In fact, this takes place automatically with the actuation of the closing device.

According to an alternative of the invention, the lifting device has a lifting platform, which is arranged in a bottom area of the vessel receiving area and which has an engagement element, which engages with a thread-like guide of the closing device. For example, the lifting platform can have a bolt, which is oriented radially outwards and which engages with a corresponding thread-like guide of the wing or of the sliding element. If the closing device has a sliding element, for example, the thread-like guide can be a groove, which rises in circumferential direction and along which the bolt is shifted into the jacket recess in response to a shifting of the sliding element. As a result of a shifting of the sliding element in the direction of the jacket recess, the lifting platform is lowered, while a shifting of the sliding element out of the jacket recess results in a lifting of the lifting platform. The lowering or lifting, respectively, of the lifting platform thus takes place because the bolt glides along a dropping or rising ramp, respectively.

According to a second embodiment alternative, it is proposed for the closing device to have a lifting element, which is in operative connection with a ramp, which is embodied on the housing, in such a manner that the lifting element can be moved along the ramp in response to an actuation of the closing device. According to this embodiment, a ramp, which provides for a rising or falling edge, respectively, is embodied on the housing of the kitchen appliance. A lifting element of the closing device, which is in contact with the vessel, glides on this ramp. The vessel can be arranged on a surface of the lifting element, for example. The lifting element glides along the ramp in response to an actuation of the closing device, that is, a pivoting of the wing or a shifting of the sliding element, whereby the lifting element glides down the ramp, in response to a movement in the direction of the jacket recess, while it glides up the ramp in response to a movement away from the jacket recess and is lifted—together with the vessel arranged thereon.

According to this embodiment alternative, the user of the kitchen appliance also needs to make only one hand movement so as to close the jacket recess on the one hand and so as to lower the vessel into the vessel receiving area or so as to open the jacket recess on the other hand and so as to lift the vessel out of the vessel receiving area.

Advantageously, it is proposed for the closing device to be in operative connection with a locking device for locking the vessel by means of a lid or to be a part of a locking device. Advantageously, the locking device can have locking elements for arrangement on the lid. According to this embodiment, the wing or the sliding element, respectively, can have a locking element, which reaches across the vessel or the lid arranged on the vessel, respectively, in the state, in which the wing/the sliding element is pivoted or shifted into the jacket recess, respectively, and is lowered onto the lid, in particular in connection with the afore-mentioned lifting device, so as to fixedly lock said lid to the vessel. The locking device can have hook elements, for example, which are oriented radially inwards, starting at the cylinder jacket.

Finally, a kitchen appliance, in particular a mixer, comprising a housing, on which a vessel can be arranged, is proposed, wherein the housing has a vessel receiving area, into which the vessel can be inserted, wherein the vessel receiving area is embodied so as to correspond to the shape of the vessel at least in a partial area in such a manner that the vessel can be oriented with regard to a vertical direction as well as with regard to a circumferential direction of the vessel in the course of the insertion into the vessel receiving area, wherein the vessel receiving area is substantially embodied as a cylinder, the cylinder jacket of which has a jacket recess, so that the cylinder is embodied so as to be substantially open on one side in circumferential direction, wherein the vessel has a partial engagement area, which is embodied so as to correspond to the shape of the jacket recess and which has a larger material thickness than the other partial areas of the vessel in circumferential direction, wherein the partial engagement area closes the jacket recess in the inserted state of the vessel.

According to this embodiment alternative, the jacket recess is closed by means of a partial engagement area of the vessel, which partial engagement area is embodied on the vessel. The partial engagement area has a larger material thickness than the other partial areas of the vessel in circumferential direction, so that the vessel effects a better soundproofing in the partial engagement area than in the other areas. It is not necessary to provide for a separate closing device on the housing so as to attain an optimal soundproofing. As a result of the larger material thickness of the partial engagement area, the outer wall of the vessel protrudes into the circumferential circular path of the cylindrical vessel receiving area and closes the latter in a shape-corresponding manner. Advantageously, the partial engagement area has a partial area, which is embodied in the manner of a ramp, so as to comfortably insert the vessel into the vessel receiving area. This ramp is suitable to glide along a correspondingly embodied partial area of the vessel receiving area until the vessel has reached the position, inside the vessel receiving area, which is lowest in vertical direction. Due to the fact that the partial engagement area is advantageously not embodied across the entire circumference of the vessel, it simultaneously fulfills the function of the relative positioning of the vessel in circumferential direction. It is also ensured in this respect that the vessel always has a certain orientation inside the kitchen appliance, for example “vessel handle towards user”. In addition to the embodiment of the partial engagement area comprising an increased material thickness, it is also possible to embody the partial engagement area with a material, which has a higher degree of soundproofing than the material in the other partial areas of the vessel.

It is proposed for the kitchen appliance to have a locking device for locking the vessel by means of a lid, wherein the locking device has a locking bracket, which is arranged on the housing and which can be pivoted about a horizontal axis and which, in the locked state, contacts a partial area of the lid. The locking device serves to lock the vessel by means of a lid. The locking bracket can be arranged on a partial circumferential area of the vessel receiving area, which faces away from the jacket recess, so that said locking bracket is pivoted beyond the vessel with regard to the locking state and engages with a closure, which is arranged in the area of the jacket recess. The closure can thereby be a spring lock or the like, for example.

It is proposed for the vessel and the vessel receiving area to have electric contacts for establishing an electric connection between the vessel and the kitchen appliance, wherein, in the course of being inserted into the vessel receiving area, the vessel can be oriented relative to the housing in such a manner that the electric contacts of the vessel and the electric contacts of the vessel receiving area contact one another. According to this embodiment, the relative orientation of the vessel in circumferential direction according to the invention is used to orient the electric contacts of the vessel and of the vessel receiving area relative to one another in such a manner that an electric connection can be established between the vessel and the kitchen appliance. The insertion of the vessel into the vessel receiving area thus becomes particularly comfortable for the user, because he does not need to make sure any longer, whether the vessel has a certain orientation to the vessel receiving area. In fact, the positioning of the vessel and thus also the positioning of the electric contacts takes place due to the fact that the vessel and the vessel receiving area correspond in shape, as explained above.

The invention will be specified in more detail below by means of exemplary embodiments.

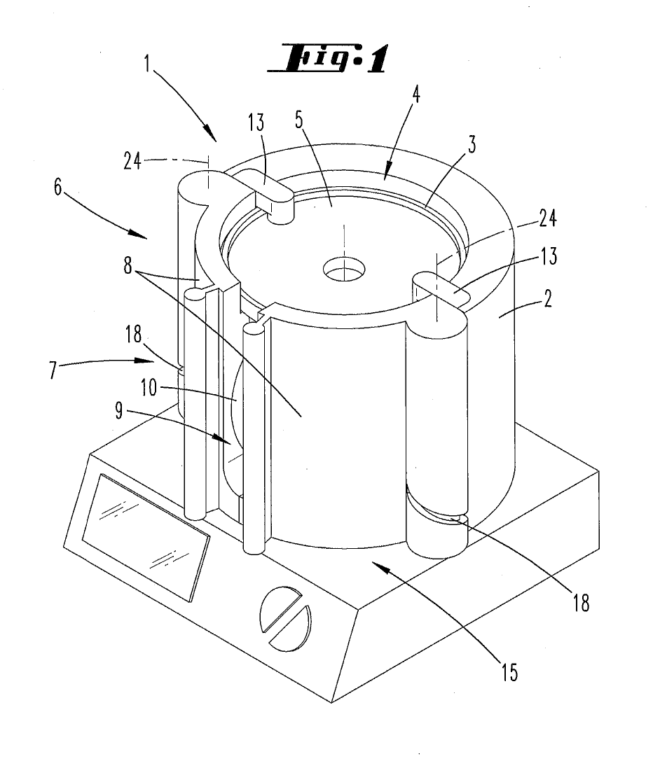

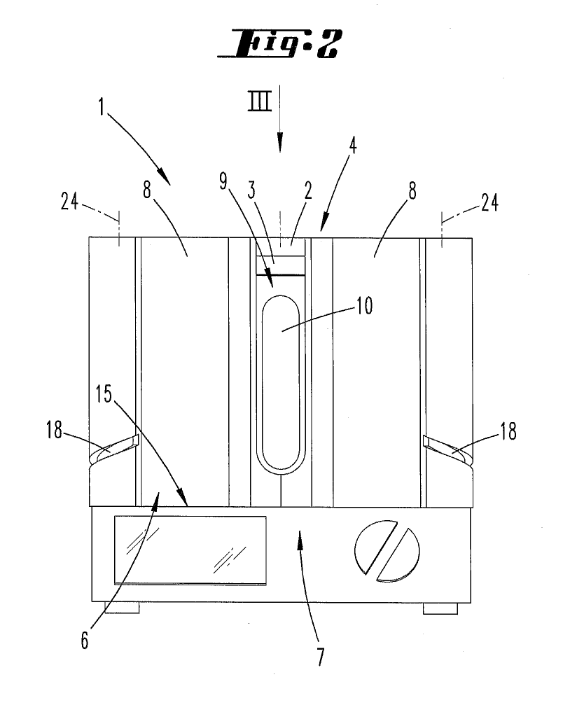

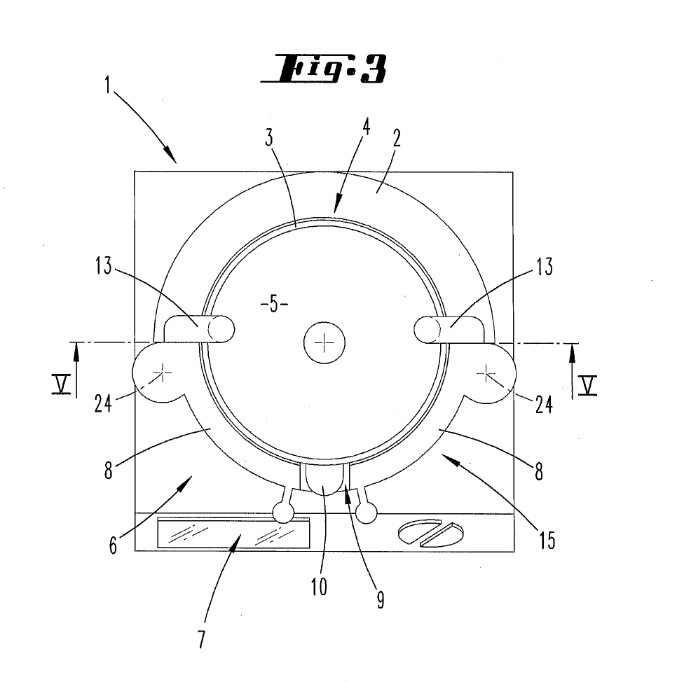

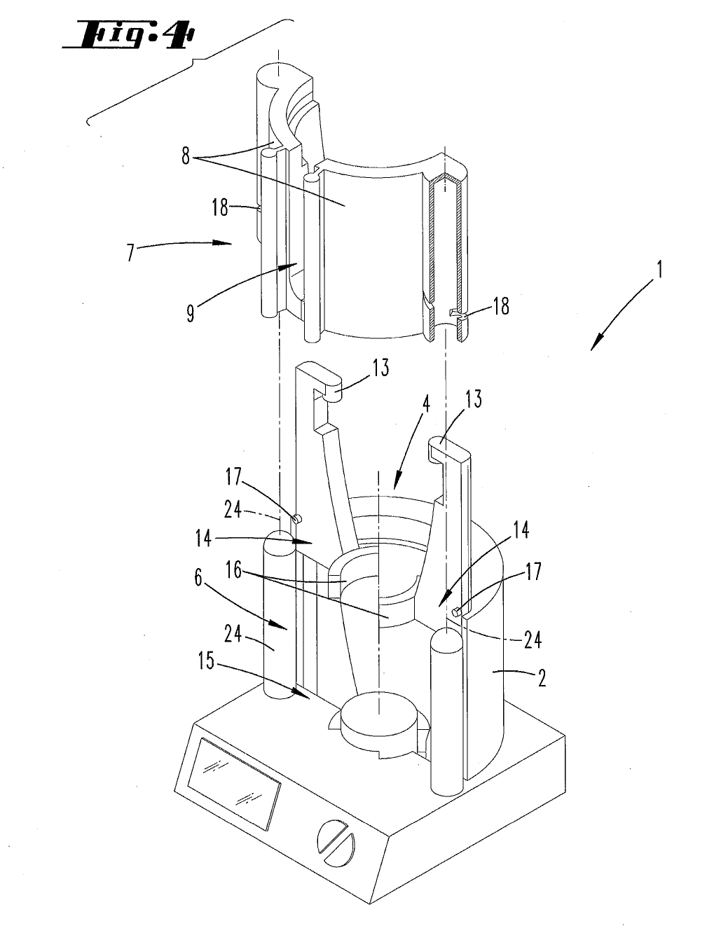

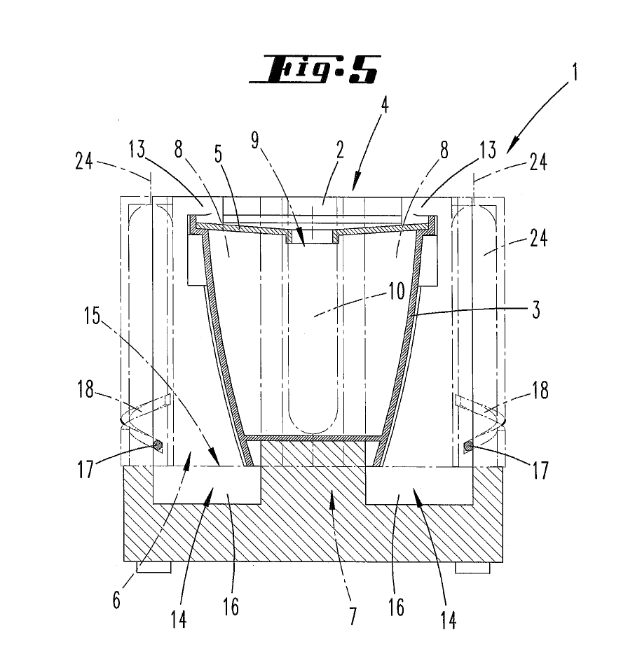

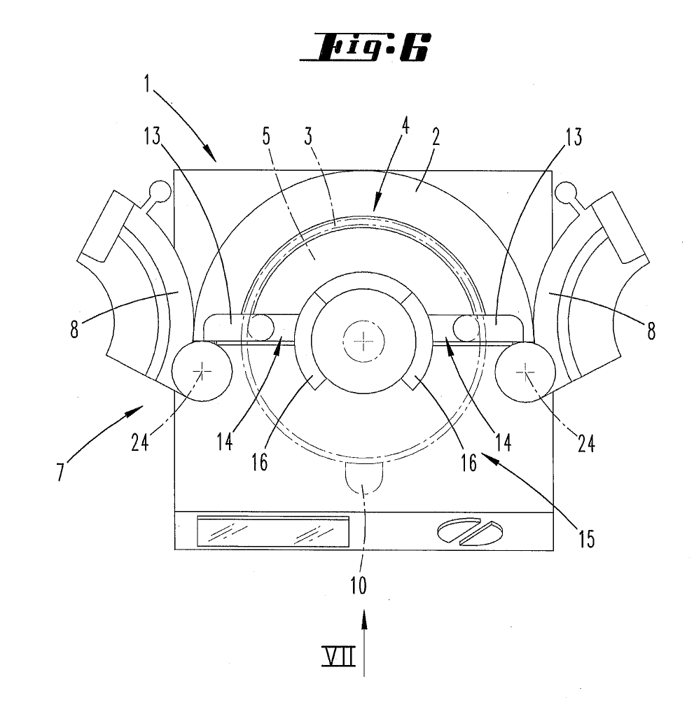

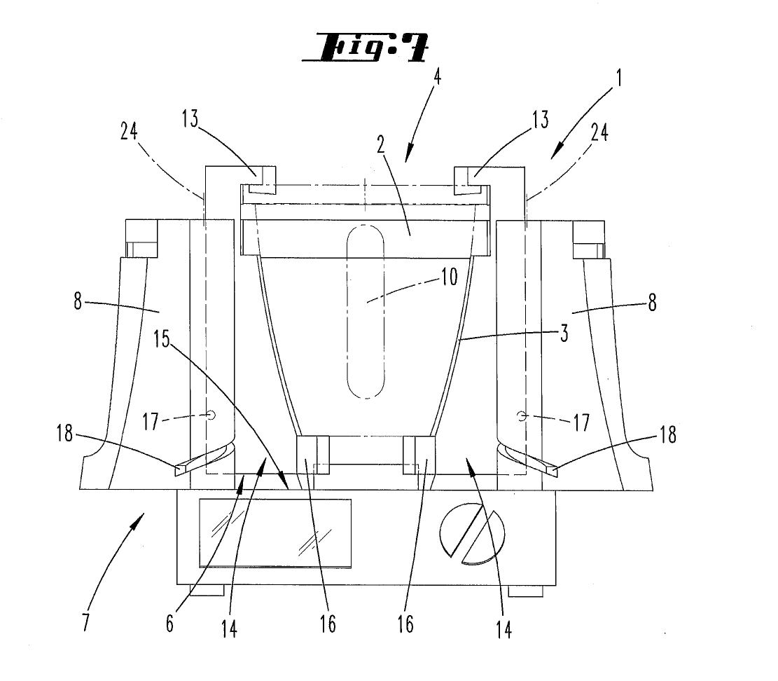

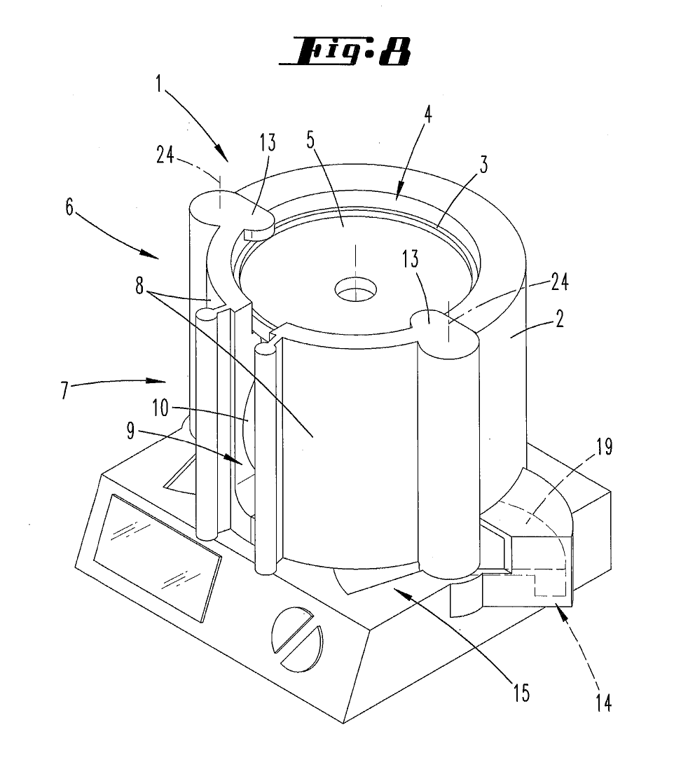

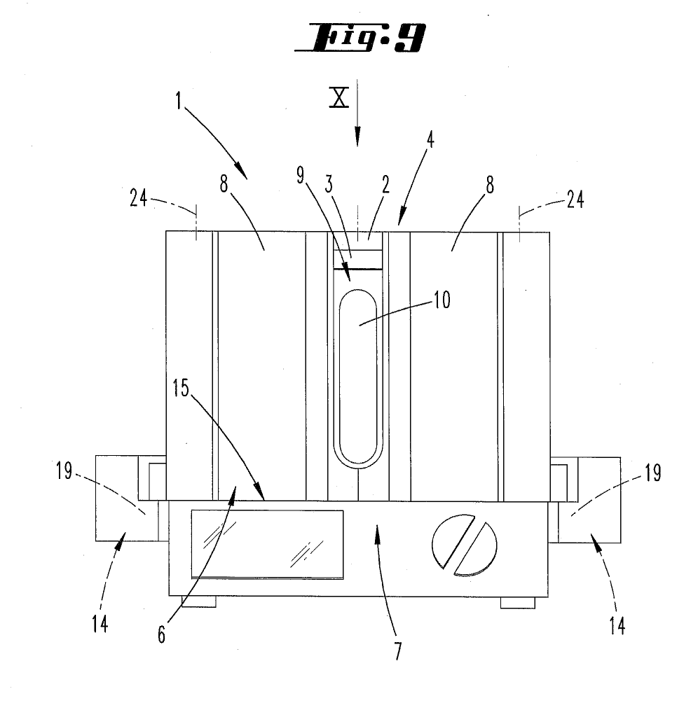

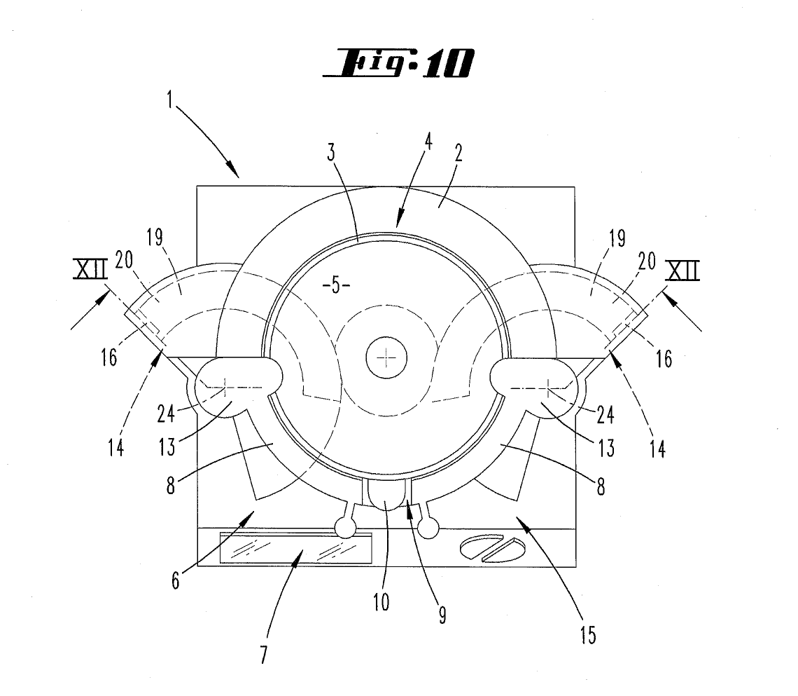

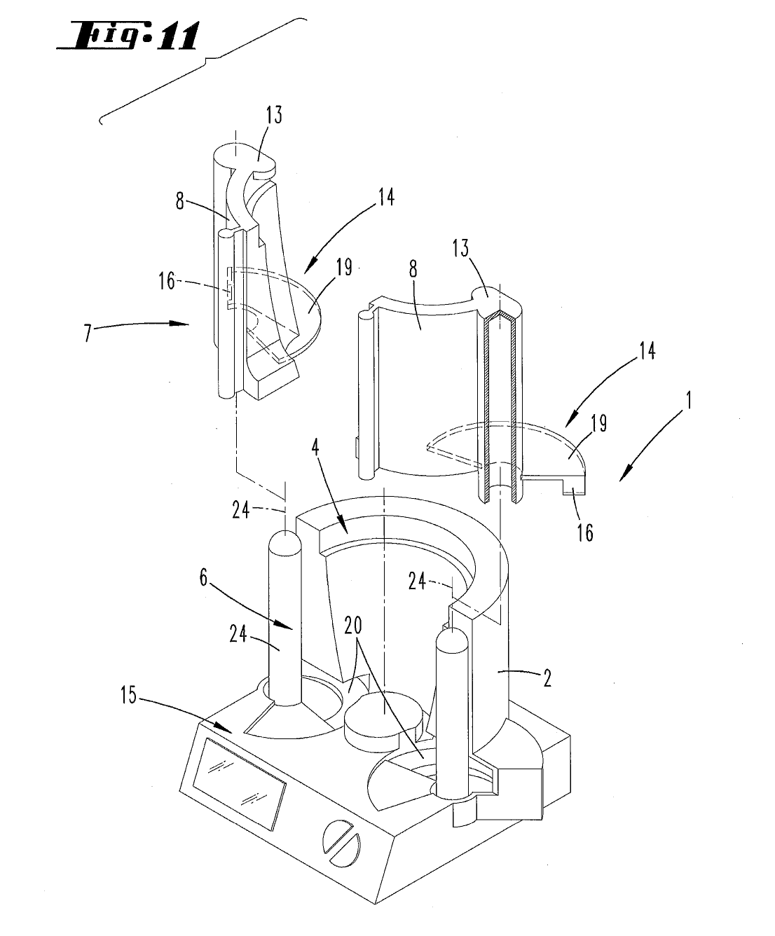

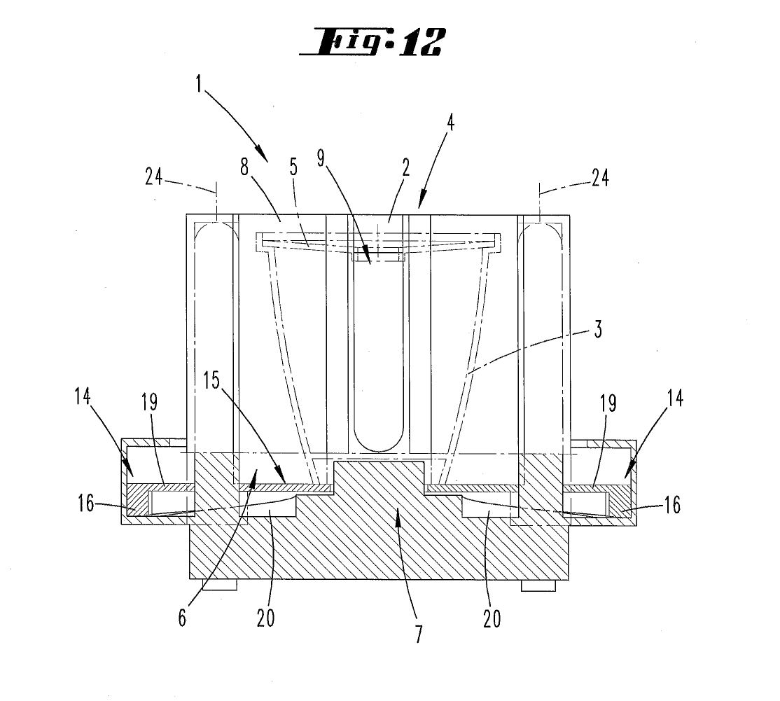

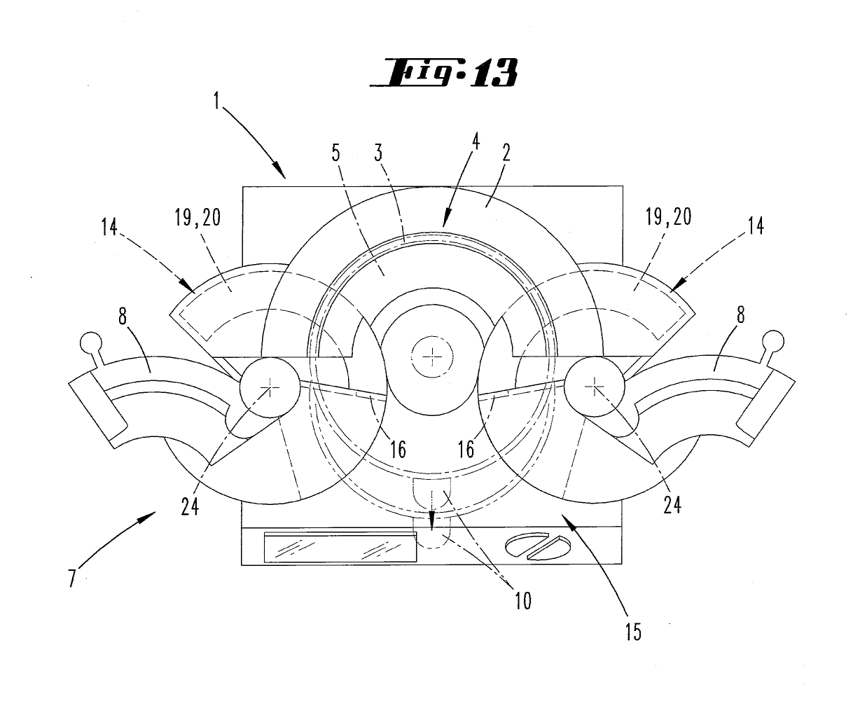

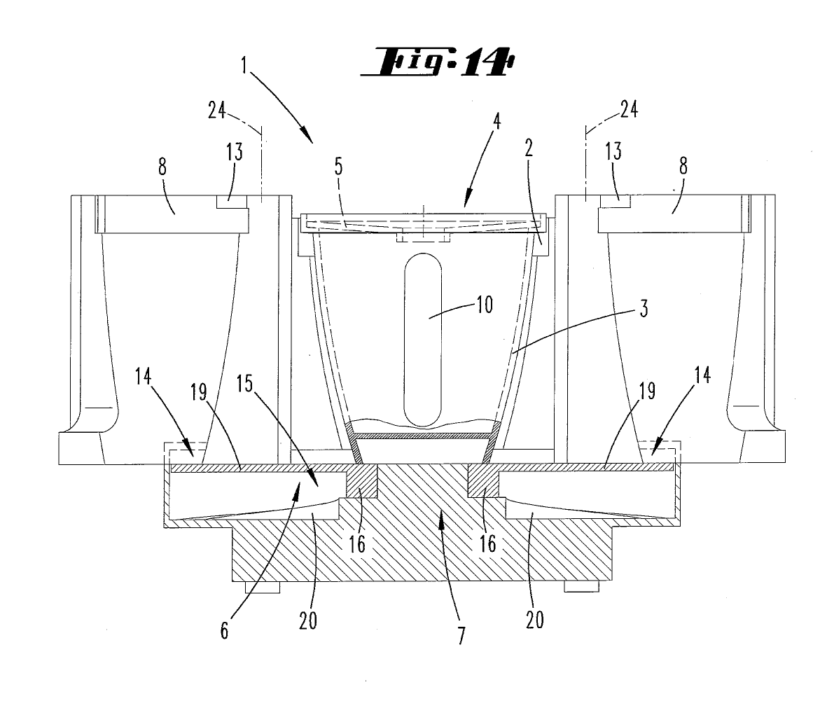

FIGS. 1 to 7 show a kitchen appliance according to a first embodiment of the invention, namely:

FIG. 1 shows a perspective view of the kitchen appliance,

FIG. 2 shows a frontal view of the kitchen appliance,

FIG. 3 shows a top view of the kitchen appliance,

FIG. 4 shows an exploded illustration of the kitchen appliance,

FIG. 5 shows a vertical cross section of the kitchen appliance,

FIG. 6 shows a top view onto the kitchen appliance comprising an open vessel receiving area,

FIG. 7 shows a frontal view of the kitchen appliance comprising an open vessel receiving area;

FIGS. 8 to 14 show a kitchen appliance according to a second embodiment, namely:

FIG. 8 shows a perspective view of the kitchen appliance,

FIG. 9 shows a frontal view of the kitchen appliance,

FIG. 10 shows a top view of the kitchen appliance,

FIG. 11 shows an exploded illustration of the kitchen appliance,

FIG. 12 shows a vertical cross section of the kitchen appliance,

FIG. 13 shows a top view onto the kitchen appliance comprising an open vessel receiving area,

FIG. 14 shows a vertical cross section of the kitchen appliance comprising an open vessel receiving area;

FIGS. 15 to 21 show a kitchen appliance according to a third embodiment, namely:

FIG. 15 shows a perspective view of the kitchen appliance,

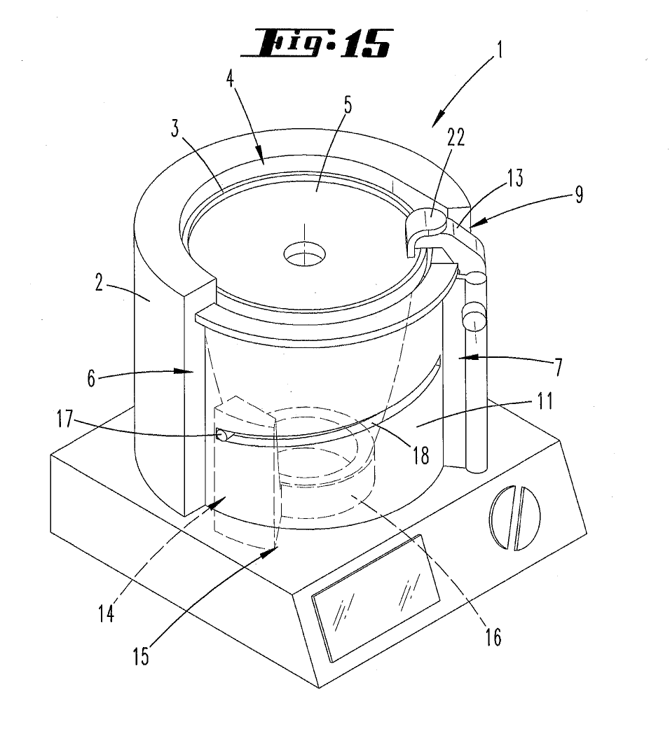

FIG. 16 shows a frontal view of the kitchen appliance,

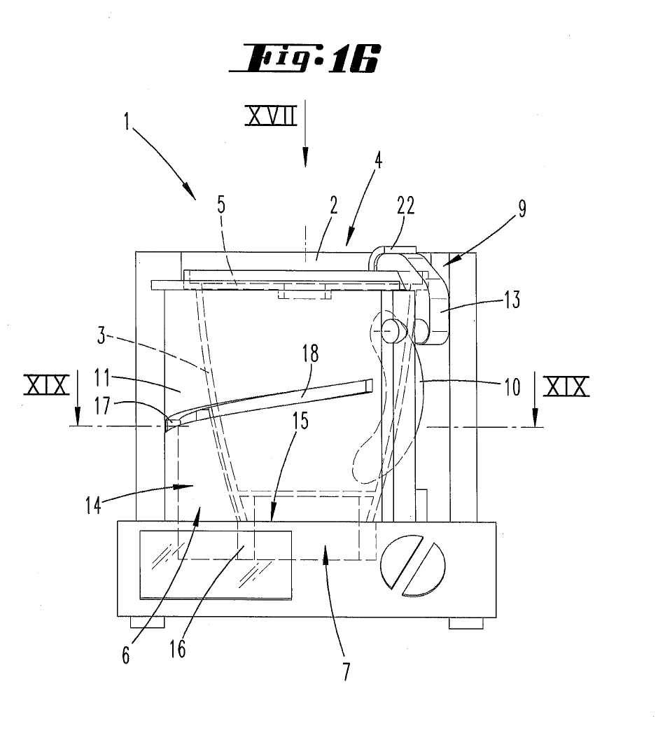

FIG. 17 shows a top view of the kitchen appliance,

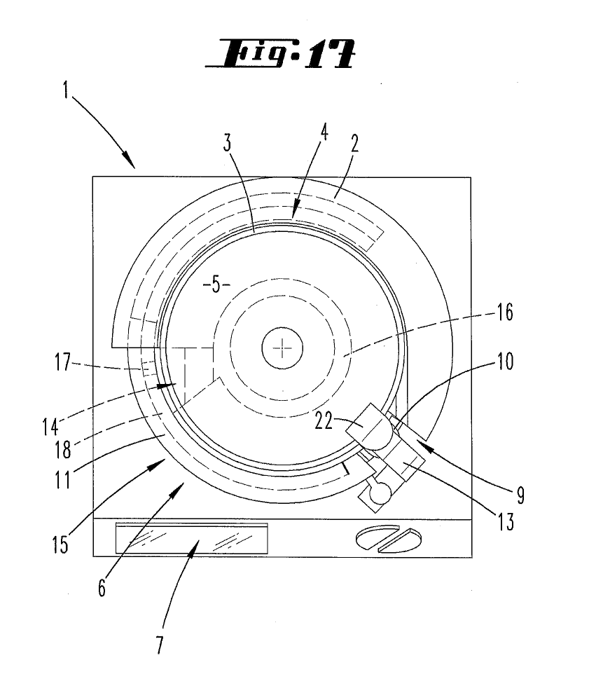

FIG. 18 shows an exploded illustration of the kitchen appliance,

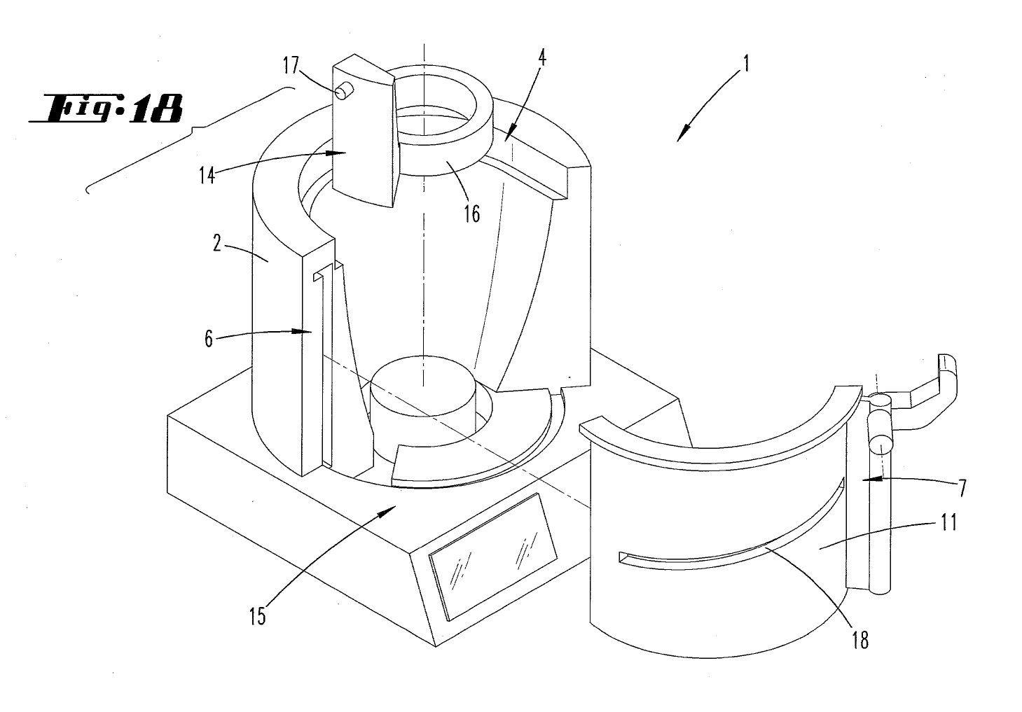

FIG. 19 shows a horizontal cross section of the kitchen appliance,

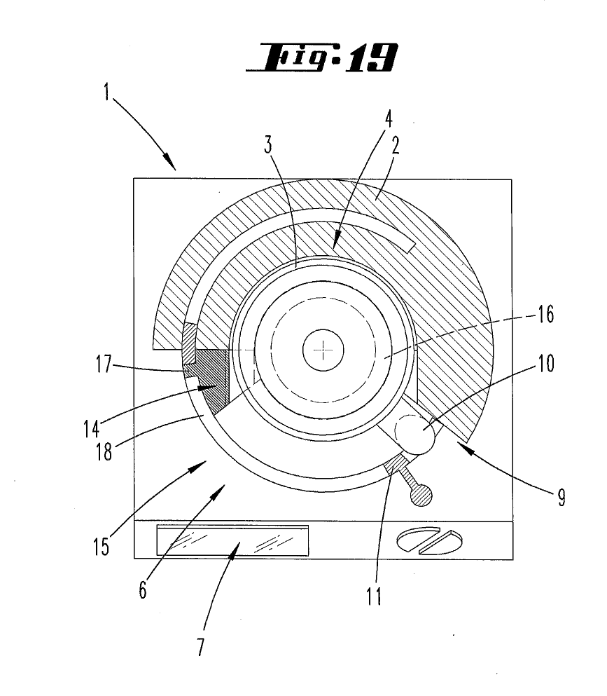

FIG. 20 shows a perspective bottom view of the kitchen appliance comprising a closed vessel receiving area,

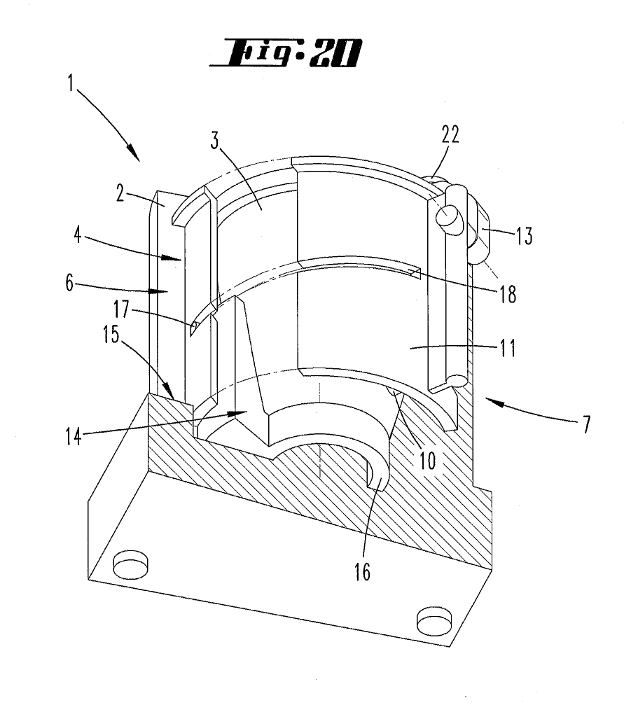

FIG. 21 shows a perspective bottom view of the kitchen appliance comprising an open vessel receiving area;

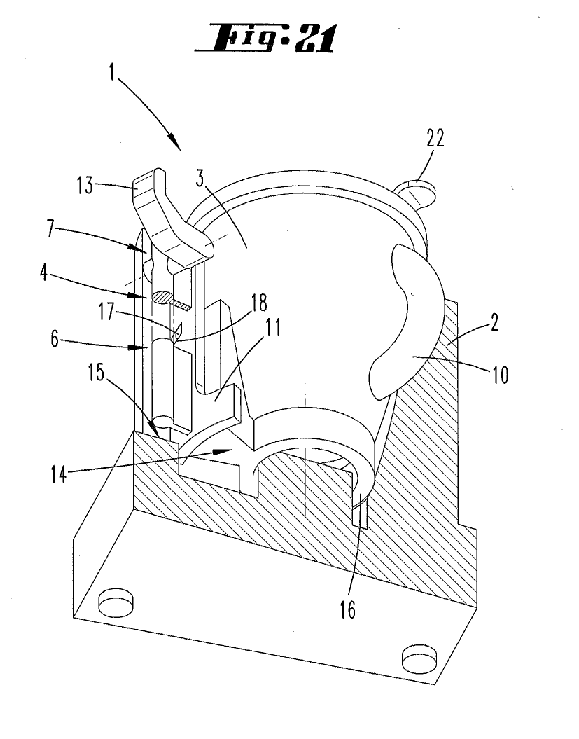

FIGS. 22 to 29 show a kitchen appliance according to a fourth embodiment, namely:

FIG. 22 shows a perspective view of the kitchen appliance,

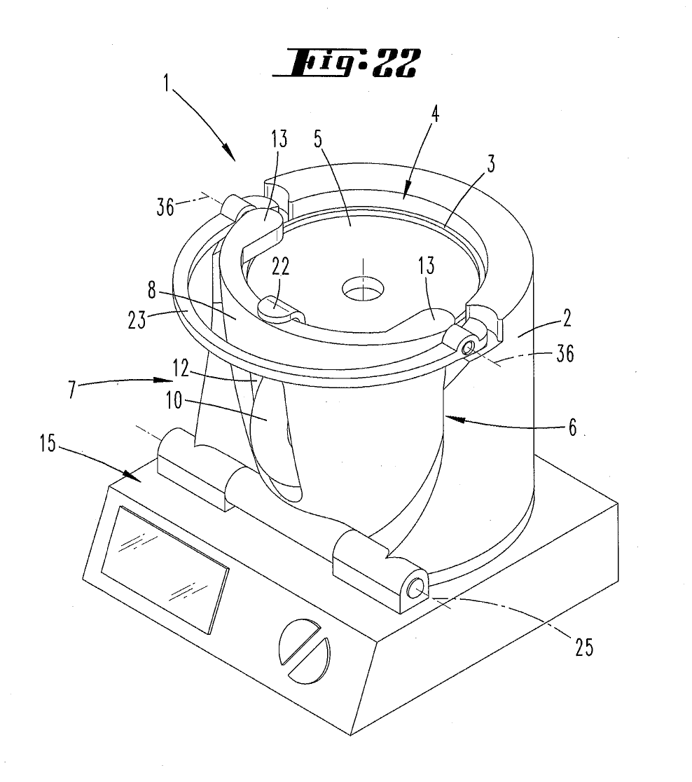

FIG. 23 shows a frontal view of the kitchen appliance,

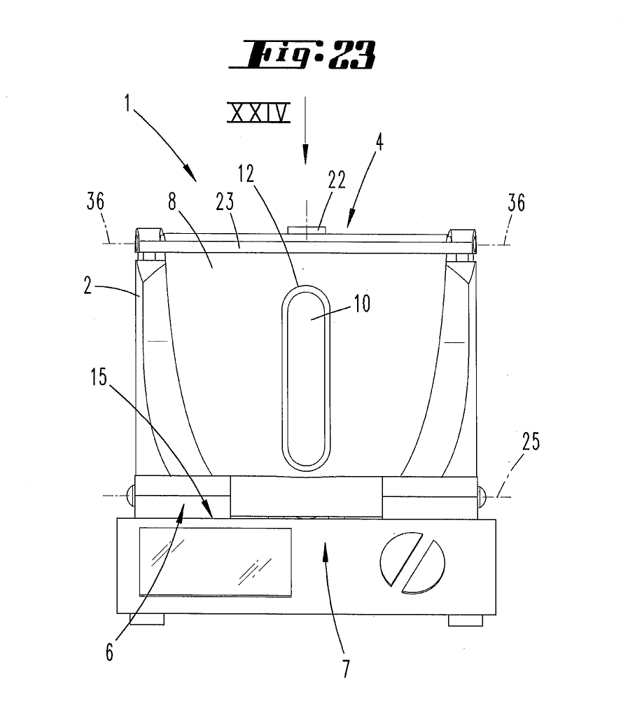

FIG. 24 shows a top view of the kitchen appliance,

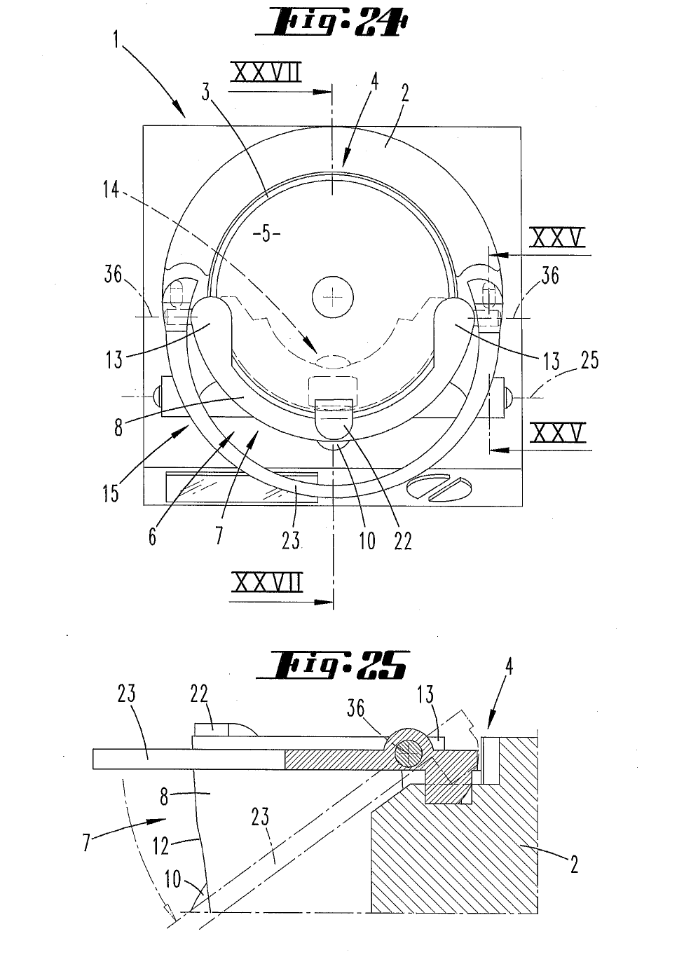

FIG. 25 shows a side view of a partial area of the kitchen appliance,

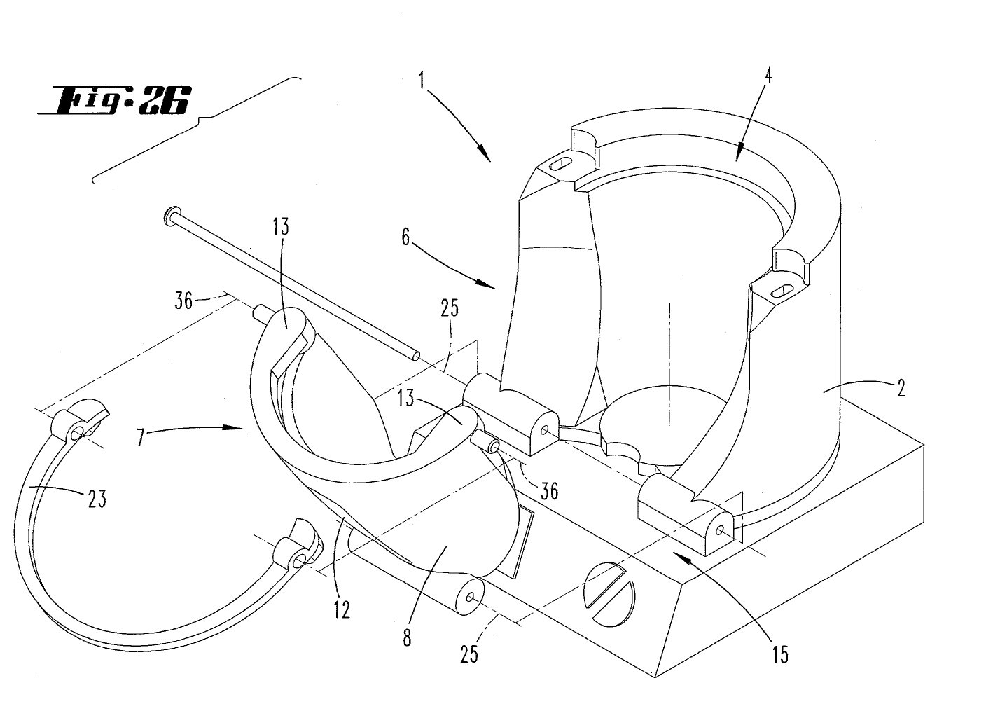

FIG. 26 shows an exploded illustration of the kitchen appliance,

FIG. 27 shows a vertical cross section of the kitchen appliance,

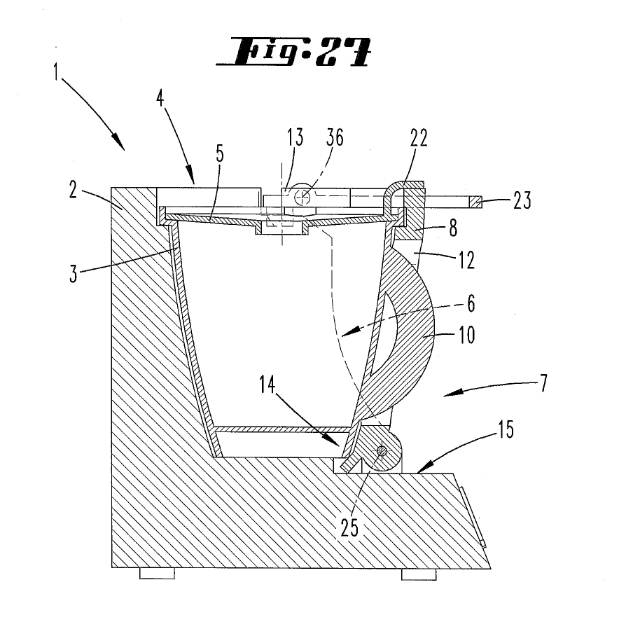

FIG. 28 shows a perspective view of the kitchen appliance comprising an open vessel receiving area;

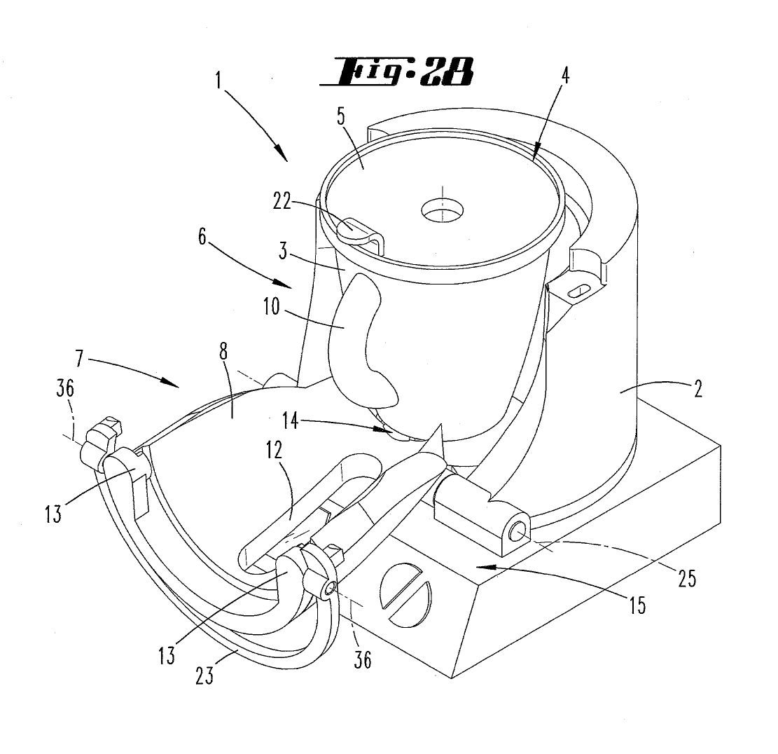

FIG. 29 shows a vertical cross section of the kitchen appliance comprising an open vessel receiving area;

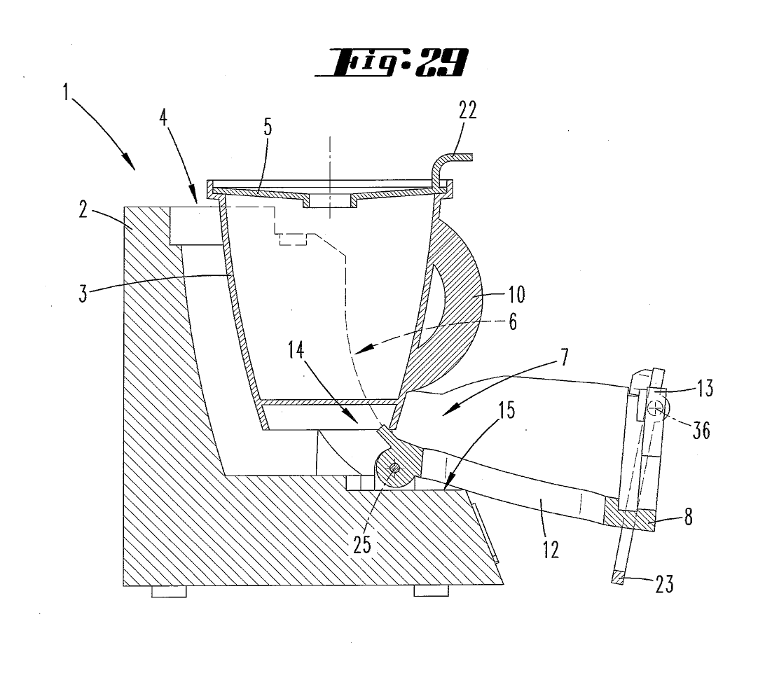

FIGS. 30 to 40 show a kitchen appliance according to a fifth embodiment alterative, namely:

FIG. 30 shows a perspective view of the kitchen appliance,

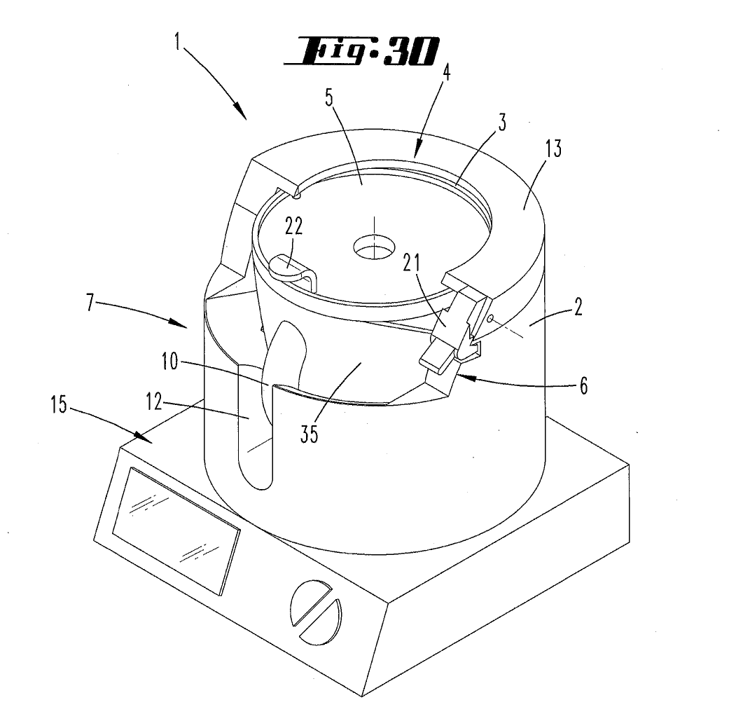

FIG. 31 shows a frontal view of the kitchen appliance,

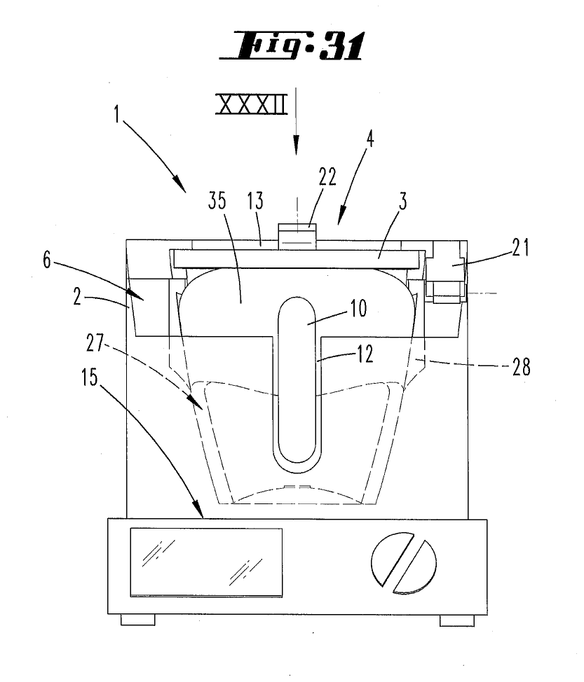

FIG. 32 shows a top view of the kitchen appliance,

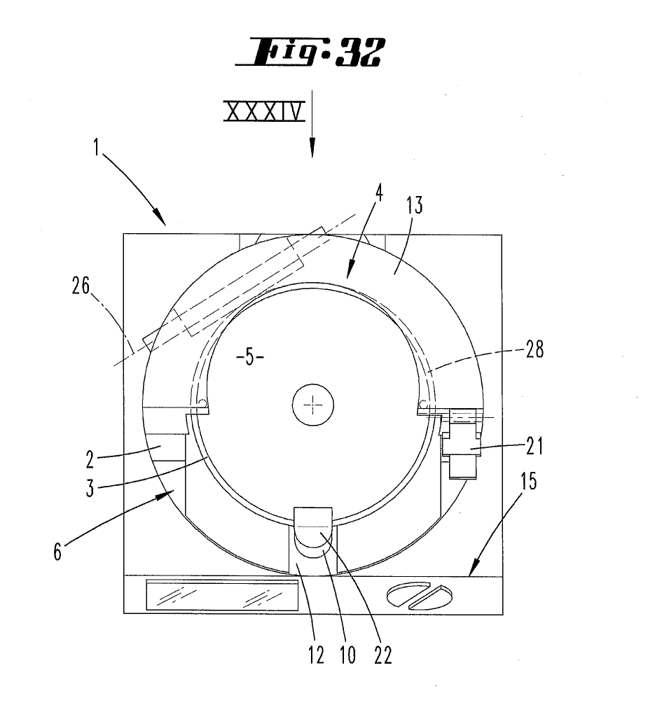

FIG. 33 shows an exploded illustration of the kitchen appliance,

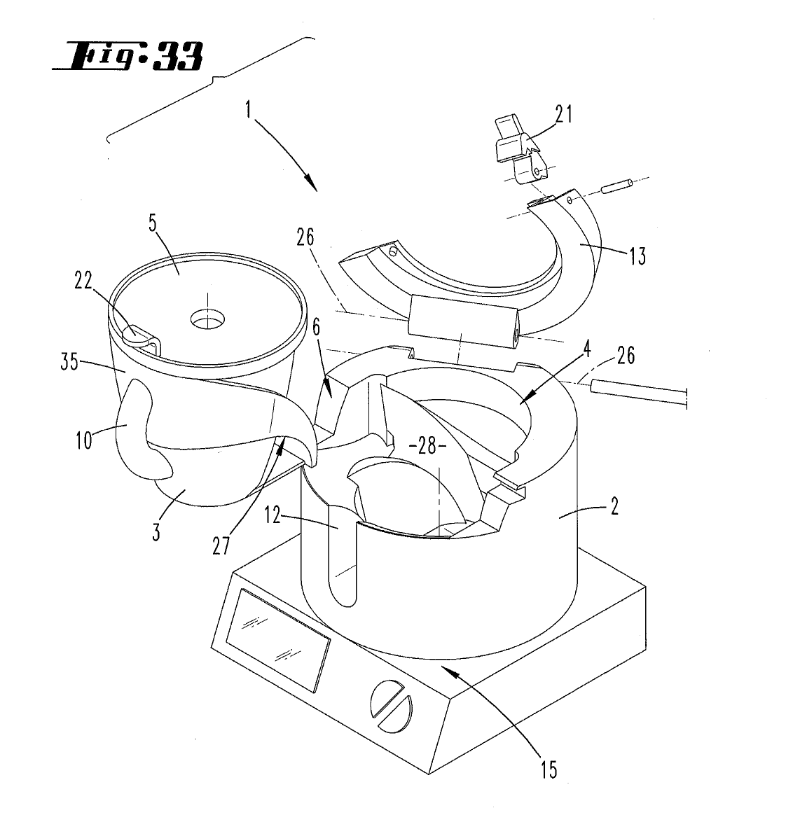

FIG. 34 shows a vertical cross section of the kitchen appliance in a rear view,

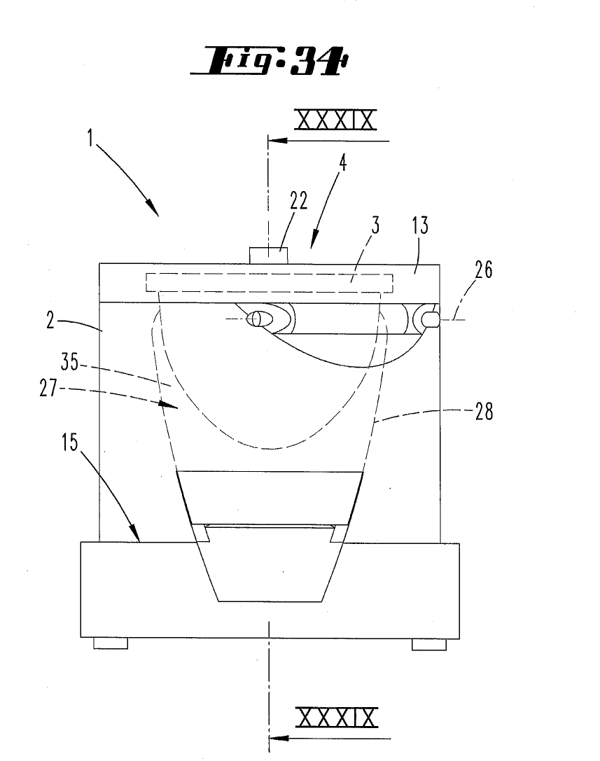

FIG. 35 shows a vessel in side view,

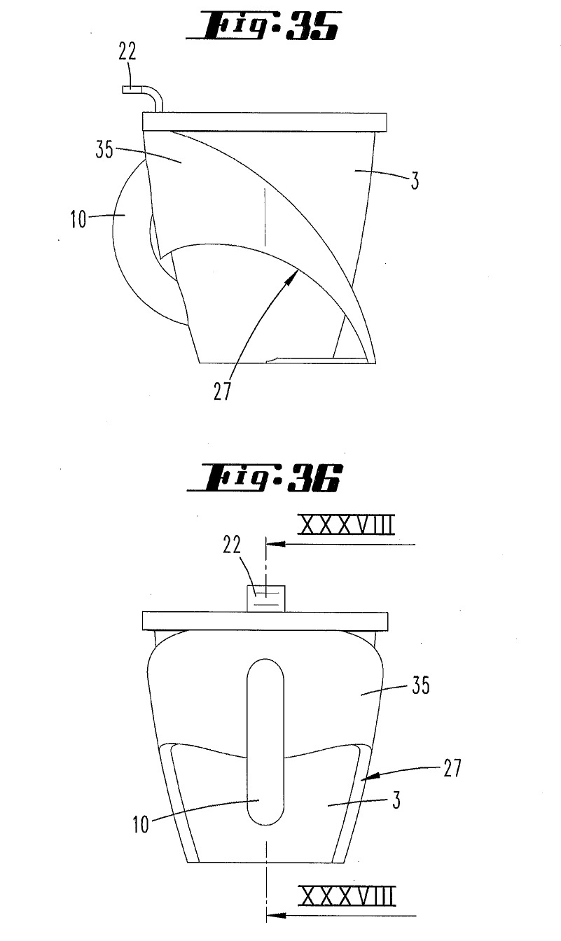

FIG. 36 shows a vessel in frontal view,

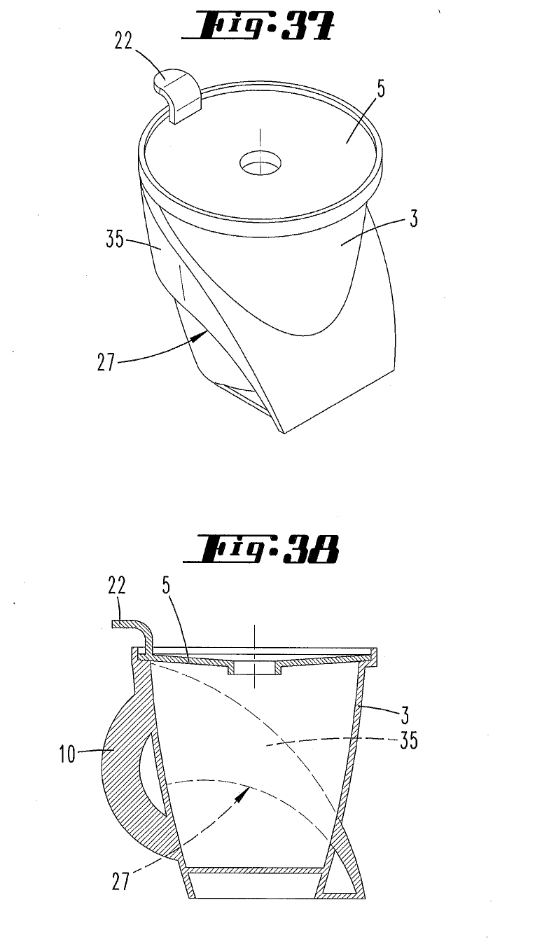

FIG. 37 shows the vessel in perspective view,

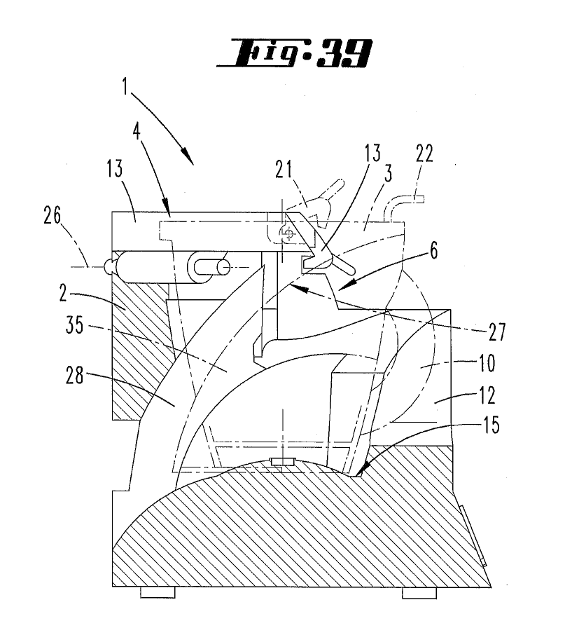

FIG. 38 shows a vertical cross section through the vessel,

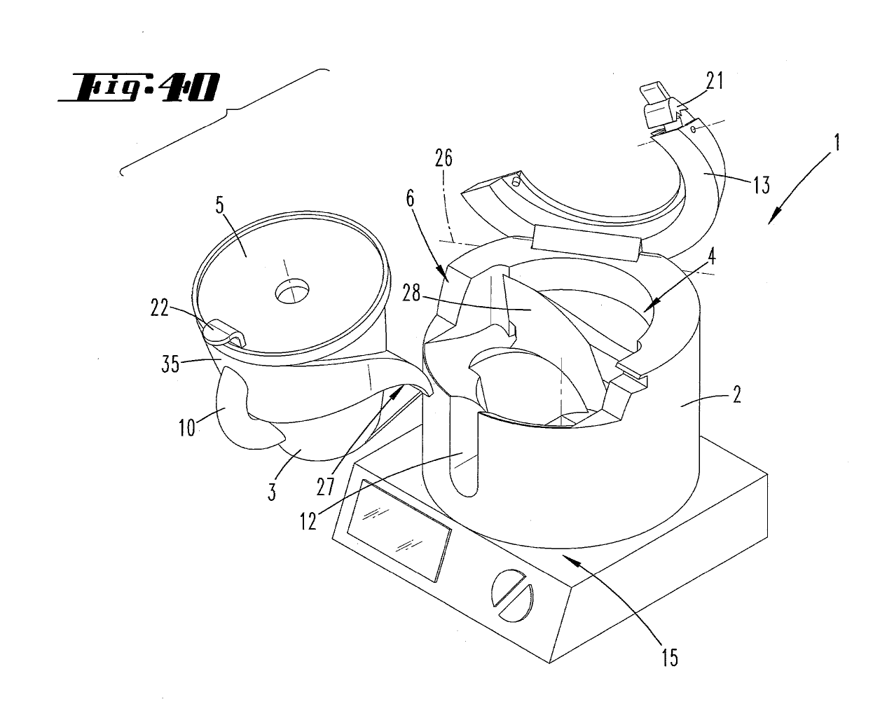

FIG. 39 shows a vertical cross section of the kitchen appliance,

FIG. 40 shows a perspective view of the kitchen appliance comprising an open vessel receiving area;

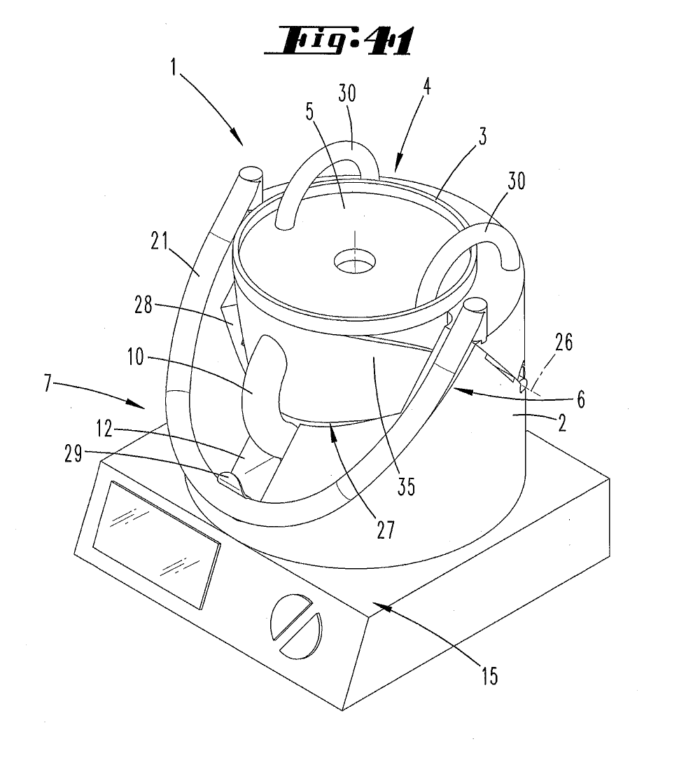

FIGS. 41 to 48 show a kitchen appliance according to a sixth embodiment alternative, namely:

FIG. 41 shows a perspective view of the kitchen appliance,

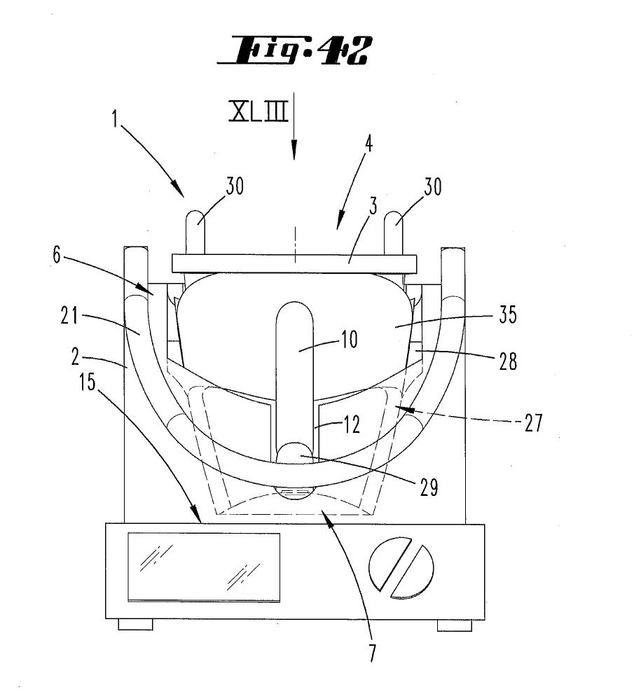

FIG. 42 shows a frontal view of the kitchen appliance,

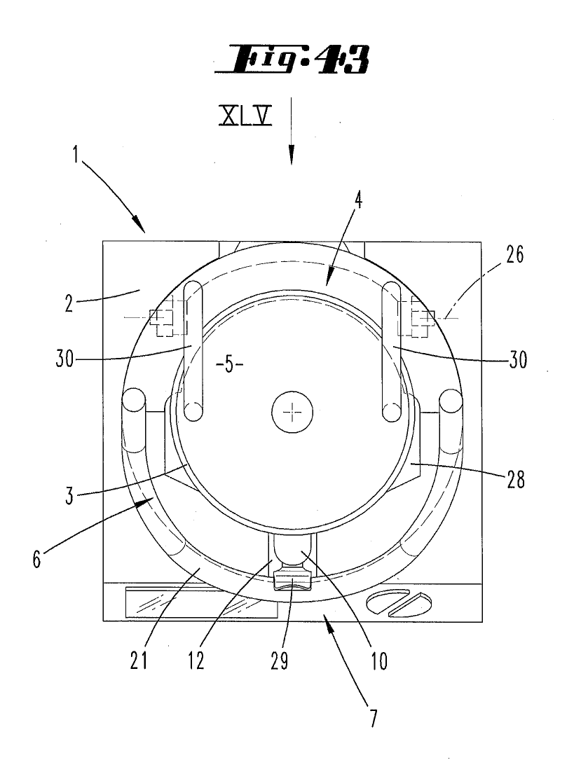

FIG. 43 shows a top view of the kitchen appliance,

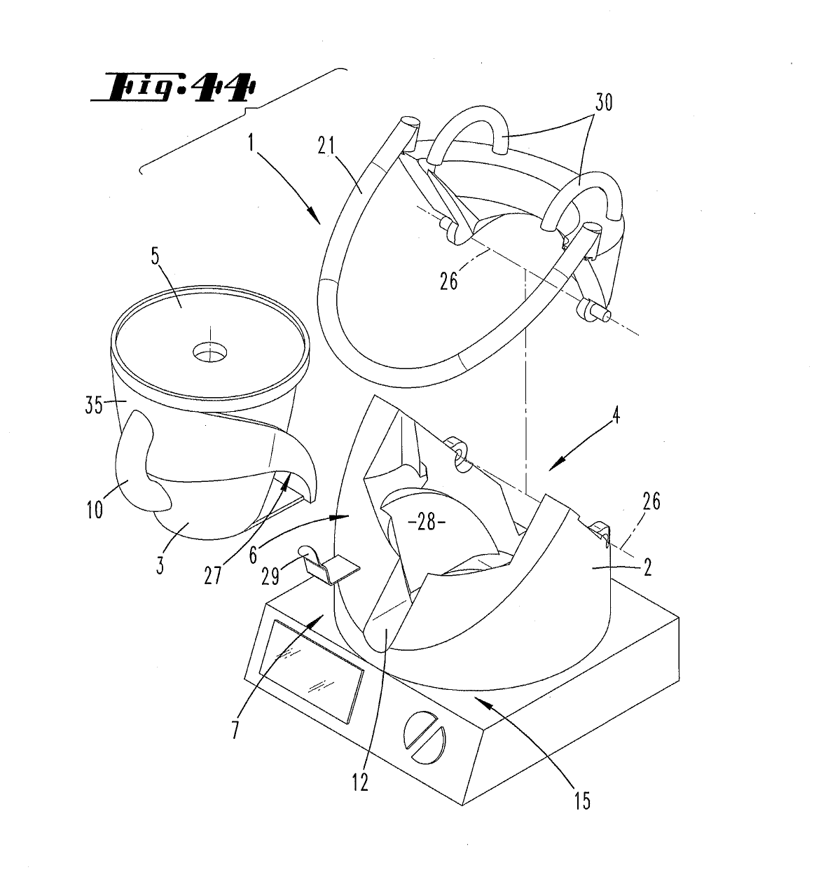

FIG. 44 shows an exploded illustration of the kitchen appliance,

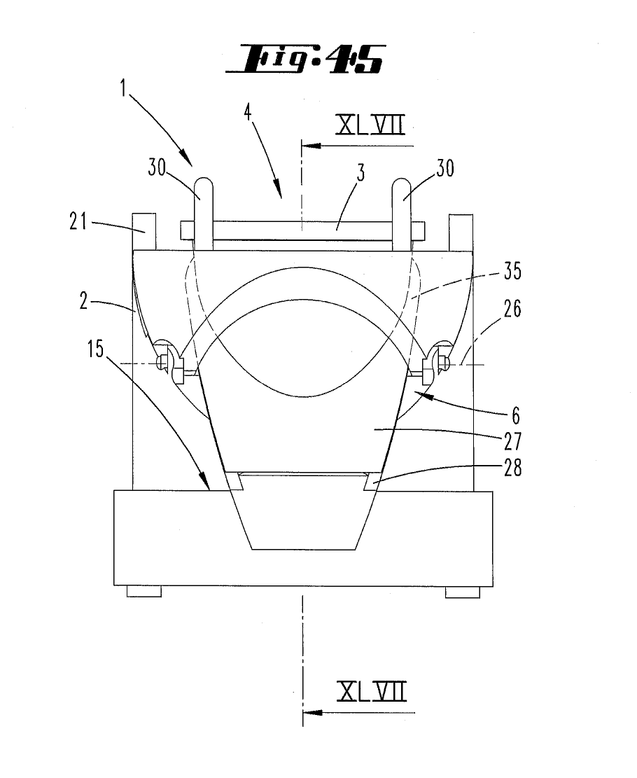

FIG. 45 shows a vertical cross of the kitchen appliance in a rear view,

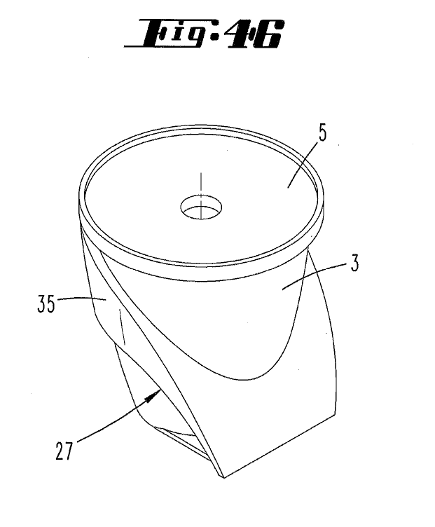

FIG. 46 shows a vessel in perspective view,

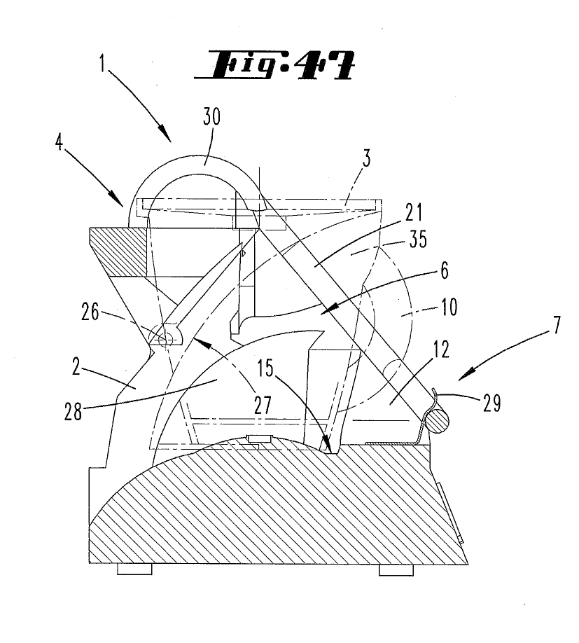

FIG. 47 shows a vertical cross section of the kitchen appliance,

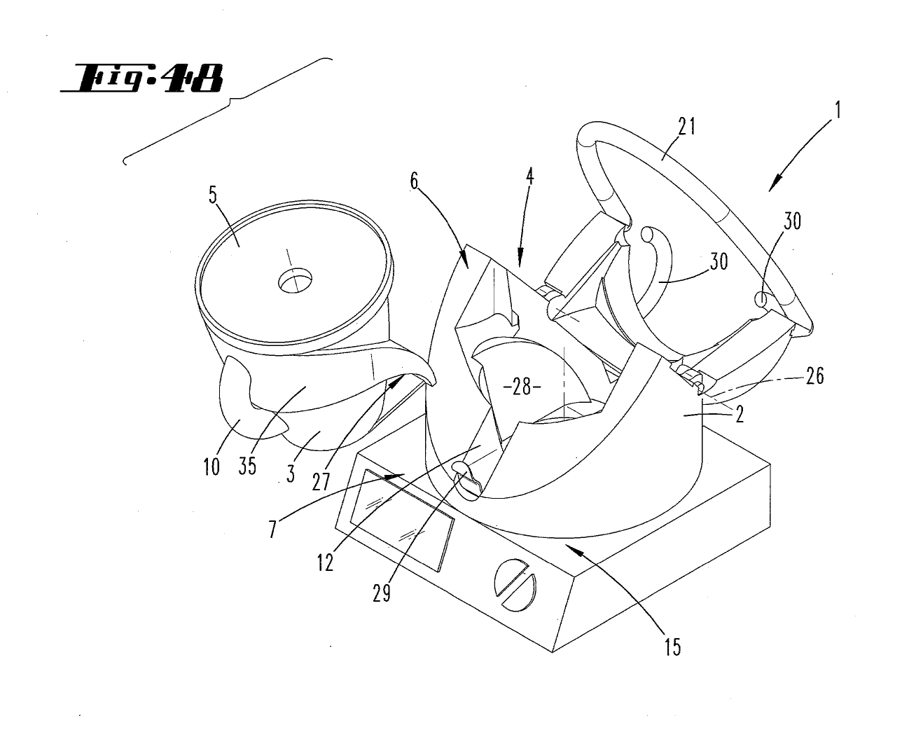

FIG. 48 shows a perspective view of the kitchen appliance comprising an open vessel receiving area,

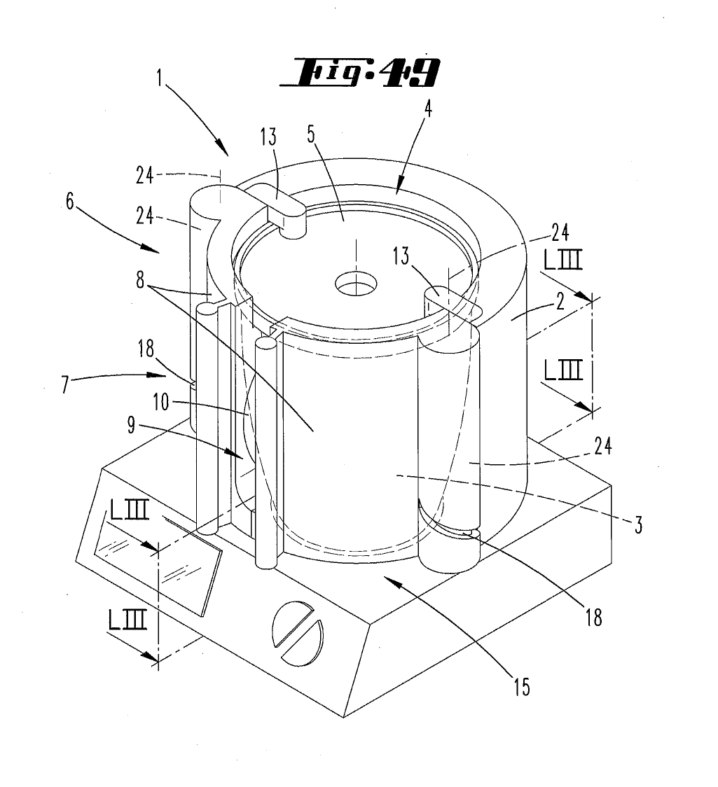

FIGS. 49 to 53 show a kitchen appliance according to a seventh embodiment alternative, namely:

FIG. 49 shows a perspective view of the kitchen appliance,

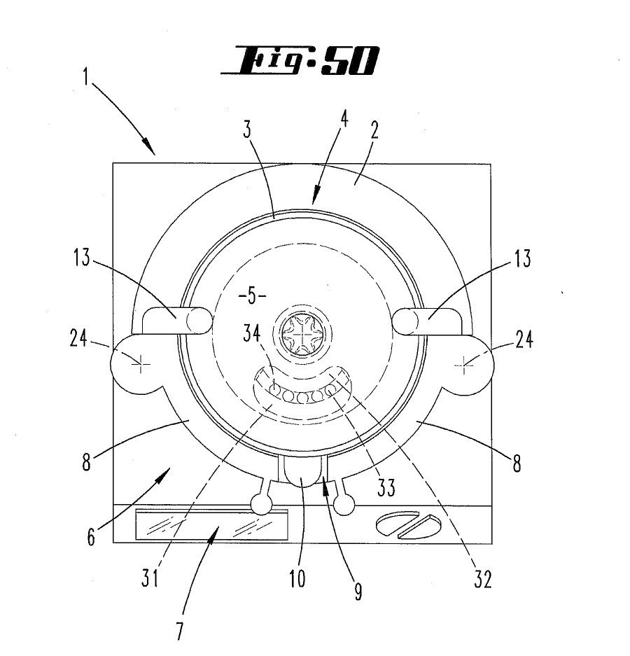

FIG. 50 shows a top view of the kitchen appliance,

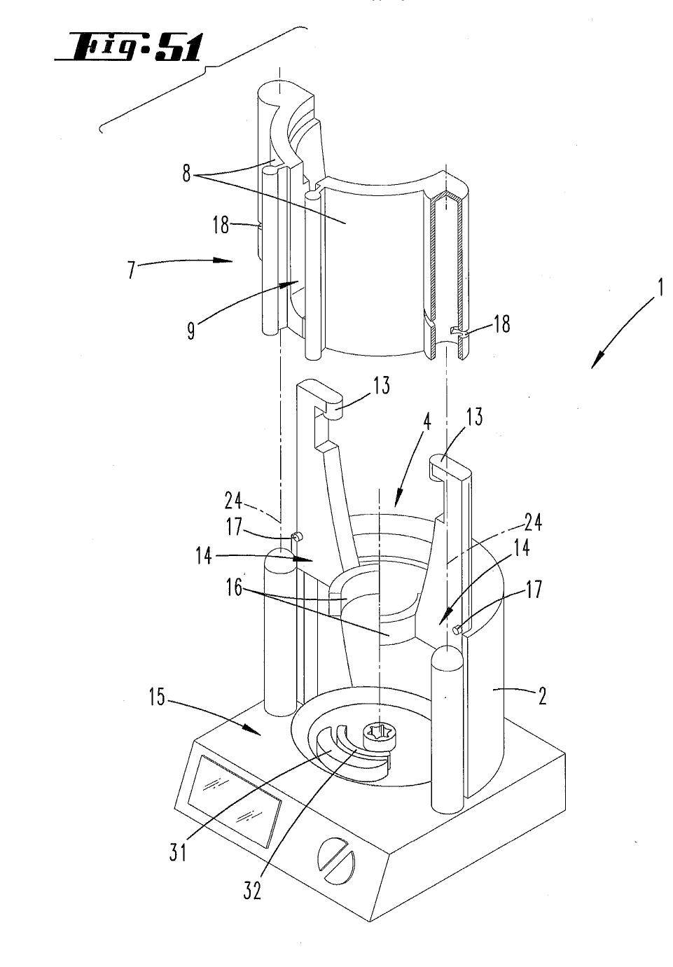

FIG. 51 shows an exploded illustration of the kitchen appliance,

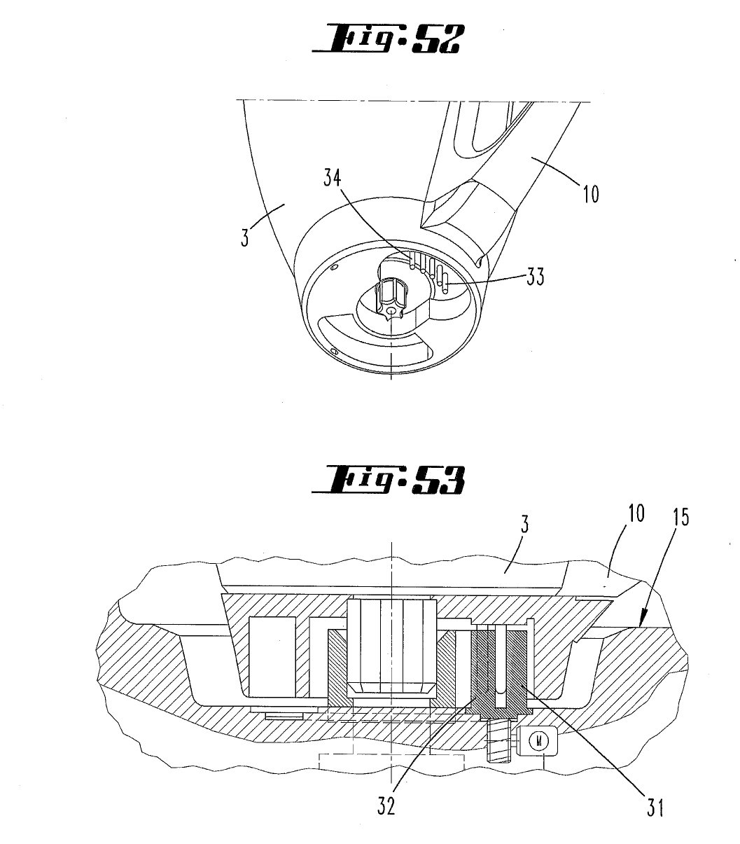

FIG. 52 shows a partial area of a vessel in bottom view,

FIG. 53 shows a vertical cross section through a partial area of the vessel.

The figures show a kitchen appliance 1, which is illustrated in a simplified manner. The shown shape of the kitchen appliance 1 is to be understood only in an exemplary manner and thus not to be limiting for the invention. The kitchen appliance 1 can be a stand mixer for preparing food, for example. The kitchen appliance 1 has a housing 2, on which a vessel 3 can be arranged. For this purpose, a vessel receiving area 4 is embodied in the housing 2. If the kitchen appliance 1 is a mixer, a mixing unit and, if applicable, a heating device, can be assigned to the vessel receiving area 4. In addition, the housing 2 of the kitchen appliance 1 has rotary switches, rotary knobs, a display, a power supply and the like in the usual manner.

According to the first exemplary embodiment shown in FIGS. 1 to 7, the kitchen appliance 1 has a housing 2 comprising a vessel receiving area 4. A vessel 3 is inserted into the vessel receiving area 4. The vessel 3 is closed by means of a lid 5. To make it possible to insert the vessel 3 comfortably into the vessel receiving area 4 of the kitchen appliance 1 and to thereby simultaneously orient the vessel 3 with regard to a vertical direction as well as with regard to a circumferential direction of the vessel 3, the vessel receiving area 4 is substantially embodied as a cylinder, the jacket of which has a jacket recess 6, which can be closed by means of at least one closing device 7, in circumferential direction. Due to the jacket recess 6, the vessel 3 can be inserted comfortably into and can be removed from the vessel receiving area 4. In the shown exemplary embodiment, the closing device 7 has two wings 8, which have a gap 9 between one another in the closed state of the closing device 7. A hand grip element 10, for example a handle of the vessel 3, can protrude through this gap 9. The two wings 8 can in each case be pivoted about a vertical axis of rotation 24.

A lifting device 14, which is in operative connection with the closing device 7, that is, one or both wings 8, is assigned to the vessel receiving area 4. The lifting device 14 has a lifting platform 16, which is arranged in a bottom area 14 of the vessel receiving area 4 and which has an engagement element 17, here a protrusion. The engagement element 17 engages with a corresponding thread-like guide 18 of the closing device 7. As a result of the incline of the thread-like guide 18 of the closing device 7, the lifting device 14 is lifted in response to a pivoting of the closing device 7 about the vertical axis of rotation 24, whereby the lifting platform 16 of the lifting device 14 is lifted simultaneously. In the illustrated exemplary embodiment, the lifting platform 16 has two ring sections, onto which the vessel 3 is placed. However, other geometric shapes of the lifting platform 16 are also possible. The lifting device 14 has two locking elements 13, which are in operative connection with the lifting platform 16 and which are lowered or lifted, respectively, simultaneously with the lifting platform 16. The lifting platform 16 is lowered in response to a pivoting of the wings 8 into the jacket recess 6, whereby the locking elements 13 are also lowered simultaneously, until they push against the lid 5, which closes the vessel 3, from the outside. The movement of the wings 8 can be coupled, so that, when one of the wings 8 is actuated, the other wing 8 is also pivoted simultaneously. In the alternative, however, it is also possible for the wings 8 to be capable of being moved independent from one another.

Advantageously, the lifting device 14 comprising the lifting platform 16 arranged thereon as well as the locking elements 13 are lowered in response to a pivoting of the wings 8 in the direction of a closing movement of the vessel receiving area 4 as a result of the engagement element 17, which runs in the guide 18 of the closing device 7, in the shown exemplary embodiment. An orientation of the vessel 3 in the circumferential direction thereof also takes place simultaneously, because the hand grip element 10 of the vessel glides along the inside of the nearest wing 8 and is shifted in the direction of the gap 9 embodied between the wings 8 in response to the pivoting of the wings 8. As soon as the wings 8 are arranged in the jacket recess 6 of the vessel receiving area 4, the hand grip element 10 of the vessel 3 reaches through the gap 9. In this orientation, the vessel 3 is arranged in a defined position and orientation inside the vessel receiving area 4 of the kitchen appliance 1.

It goes without saying that the lifting device 14, the locking elements 13 and the wings 8 can also be operated independent from one another as an alternative to the described operative connection between the pivot movement of the closing device 7 and the locking of the lid 5 on the vessel 3. In addition to the locking according to the invention, the shown embodiment of the vessel receiving area 4 also offers a soundproofing function, because the vessel 3 is completely surrounded by the housing 2 of the kitchen appliance 1 in circumferential direction. Noises, which are created inside the vessel 3 as a result of the preparation of food, are absorbed optimally, so that the operation of the kitchen appliance 1 is particularly quiet.

The kitchen appliance 1 shown in FIGS. 8 to 14 also has a housing 2 comprising a vessel receiving area 4, into which a vessel 3 can be inserted. Two wings 8, each of which can be pivoted about a vertical axis of rotation 24, are also arranged on the housing 2. In a state of the wings 8, in which the jacket recess 6 is pivoted, a gap 9, through which a hand grip element 10 of the vessel 3 can reach, is embodied between the wings 8. The wings 8 in each case have a locking element 13, which, in the closed state of the vessel receiving area 4, pushes against the lid 5 of the vessel 3 and thus locks the vessel 3.

A lifting device 14, which has interacting areas in the housing 2 of the kitchen appliance 1 as well as on the wings 8, is assigned to the wings 8. The wings 8 in each case have a lifting element 19, which is arranged on the end of the wing 8, which faces the bottom area 15 of the vessel receiving area 4. The bottom area 15 of the housing 2 has a ramp 20, along which a partial area of the lifting element 19 runs. In response to a pivoting of the wing 8 from an open position of the vessel receiving area 4 into a closed position, the lifting element 19 runs down the ramp 20, thus resulting in a lowering of the lifting element 18. At the same time, the vessel 3 is lowered into the vessel receiving area 4 due to the fact that the vessel 3 is arranged on the lifting elements 19 of the wings 8. In the closed position of the vessel receiving area 4, the locking elements 13 simultaneously engage with the lid 5 and lock the vessel 3 by means of the lid 5. In response to the correspondingly opposite pivot movement of the wings 8, the lifting elements 19 run up the ramps 20, so that the vessel 3, which stands on the lifting elements 19, is lifted. When the jacket recess 6 is opened completely, the user of the kitchen appliance 1 is able to remove the vessel 3 out of the housing 2 of the kitchen appliance 1 in a particularly comfortable manner.

FIGS. 15 to 21 show a third embodiment of the invention, in the case of which the jacket recess 6 embodied in the housing 2 of the kitchen appliance 1 is closed by means of a closing device 7 in the manner of a sliding element 11. Even though only a single sliding element 11 is shown here, the invention can by all means also be embodied with two sliding elements 11. In the open state of the vessel receiving area 4, the sliding element 11 can be inserted into a partial area of the housing 2 of the kitchen appliance 1. The shown kitchen appliance 1 has a lifting device 14, which has a lifting platform 16 for the vessel 3, a thread-like guide 18 inside the sliding element 11 and an engagement element 17, which engages with the guide 18 and which is in operative connection with the lifting platform 16. In the shown exemplary embodiment, the lifting platform 16 is illustrated as ring-shaped area, onto which the vessel 3 can be placed. As a result of the operative connection between the sliding element 11 and the lifting platform 16, the lifting platform 16 is lifted when the sliding element 11 is slid out of the jacket recess 6, so that the vessel 3 is lifted in the vessel receiving area 4 and can thus be accessed in a particularly simple manner by a user of the kitchen appliance 1. A locking element 13, which the user of the kitchen appliance 1 can pivot manually, is arranged on the sliding element 11, so that the locking element 13 reaches across the edge of the vessel 3 and can lock the lid 5 to the vessel 3. A lid lug 22, which is arranged on the lid 5, can furthermore be engaged with the locking element 13, for example to ensure a particular orientation of the lid 5 on the vessel 3 and/or to prevent the movement of the lid 5 in axial and/or circumferential direction.

Starting at the closed position of the vessel receiving area 4, a gap 9, through which a hand grip element 10 of the vessel 3 can reach, is arranged between the sliding element 11 and the housing 2 according to this embodiment alternative. This leads to an orientation of the vessel 3 in the circumferential direction in response to a shifting of the sliding element 11 into the jacket recess 6. So as to be able to remove the vessel 3 from the housing 2 of the kitchen appliance 1 based on this, the locking element 13 is first released from the vessel 3 or the lid 5, respectively. The sliding element 11 is then pushed out of the jacket recess 6 (to the left in FIG. 15). As a result of the sliding movement, the engagement element 17 of the lifting device 14 is moved upwards inside the guide 18 of the sliding element 11. This leads to a lifting of the lifting platform 16, on which the vessel 3 is arranged. In the maximally open position of the jacket recess 6, the vessel 3 is thus lifted relative to the vessel receiving area 4, so that the vessel can be removed from the housing 2 of the kitchen appliance 1.

FIGS. 22 to 29 show a fourth embodiment of the invention. According to this embodiment, the closing device 7 is embodied as a wing 8, which can be pivoted about a horizontal axis of rotation 25. The wing 8 has a recess 12, into which a hand grip element 10 of the vessel 3 can be inserted. Locking elements 13, which reach across the edge of the vessel 3 and which lock the vessel 3 by means of the lid 5 in the closed state of the vessel receiving area 4, are embodied on the wing 8. In addition, an additional element 23, which effects a locking between the wing 8 and the housing 2 of the kitchen appliance 1, is arranged on the wing 8. The additional element 23 can be pivoted about a horizontally oriented axis 36, wherein a partial area of the additional element 23 can engage with a corresponding partial area of the housing 2. For example, the additional element 23 can have protrusions, which can engage with recesses of the housing 2. Advantageously, the additional element 23 is embodied as bracket, so that the user of the kitchen appliance 1 can seize the additional element 23 in a particularly comfortable manner and can thus eliminate the locking between the wing 8 and the housing 2 and can simultaneously also pivot the wing 8 down into the open position. A lifting device 14 is embodied on the wing 8, here concretely as hook-shaped protrusion of the wing 8. The vessel 3 can be placed onto this lifting device 14, wherein the vessel 3 is simultaneously also lifted or lowered in response to a pivoting of the wing 8.

FIGS. 30 to 40 show a fifth embodiment of the invention. The insertion of the vessel 3 into the housing 2 or the lifting of vessel 3 from the housing 2 of the kitchen appliance 1, respectively, takes place only manually by the user of the kitchen appliance 1. To facilitate the insertion or removal of the vessel 3, respectively, into or from the housing 2, the housing 2 is provided with a jacket recess 6, so that the vessel 3 is enveloped only up to half of its height, for example, at least across a circumferential area of approximately 180 degrees. To be able to provide the position and orientation of the vessel inside the housing 2 of the kitchen appliance 1, the vessel 3 has a partial engagement area 35 comprising a vessel guide 27, which corresponds to a housing guide 28 of the housing 2. The vessel guide 27 can be embodied on the outer wall of the vessel 3, namely the partial engagement area 35, in a ramp-shaped manner, it can in particular be embodied in one piece with the vessel 3. The particular shape of the partial engagement area 35 and of the vessel guide 27 ensures that the vessel 3 can only be inserted into the housing 2 with a certain orientation. If the vessel 3 is held in such a manner that the vessel guide 27 cannot glide along the housing guide 28, the user of the kitchen appliance 1 is not able to insert the vessel 3 into the vessel receiving area 4. The partial engagement area 35 can also perform a soundproofing function, so as to absorb the noises, which are created inside the vessel 3 in response to the preparation of food.

As soon as the vessel 3 is positioned inside the housing 2 with the desired orientation, a locking element 13, which is arranged on the housing 2, can lock the vessel 3 by means of the lid 5. For this purpose, the locking element 13 is arranged on the housing 2 so as to be capable of being pivoted about an axis 26. In the locked state, the locking element 13 contacts a partial area of the lid 5 and pushes the lid 5 onto the vessel 3. In the shown embodiment alternative, the locking element 13 can be pivoted about an axis 26, which is arranged horizontally, runs tangentially to the vessel 3 and runs at an angle to the front of the kitchen appliance 1. As a result of this embodiment, a steady force is exerted on the lid 5. In addition, the locking element 13 can have a locking appendage 21, which is in operative connection with a partial area of the housing 2. If applicable, the guide of the vessel 3 can be supported by additional guide brackets, which are arranged inside the vessel receiving area 4, in response to the insertion into the vessel receiving area 4. These guide brackets can be metal brackets, for example.

FIGS. 41 to 48 show a sixth embodiment of the invention. According to this embodiment alternative, the locking device has a locking bracket 37 comprising bracket appendages 30, which is arranged on the vessel receiving area 4 and which can be pivoted about a horizontal axis 26. When the locking bracket 37 is pivoted upwards, an upper partial area of the vessel 3 can be accessed completely, so that the user can remove the vessel 3 from the housing 2 of the kitchen appliance 1 particularly easily. The bracket appendages 30, which push against the lid 5 in the locked state of the locking device and which thus lock the vessel 3, are arranged on the locking bracket 37.

As already described above with regard to the fifth embodiment alternative (FIGS. 35 to 38), the vessel 3 has a partial engagement area 35 comprising a ramp-like vessel guide 27, which can glide on a shape-corresponding housing guide 28 of the housing 2, so that the vessel 3 can automatically be inserted into the desired lowest position inside the vessel receiving area 4 and simultaneously assumes a certain orientation in circumferential direction of the vessel 3. A spring element 29, with which the locking bracket 37 can engage in the locked state, is arranged on the housing 2, here the bottom area 15. The spring element 29 can be a metal bracket, for example, behind which the locking bracket 37 can snap. As already proposed previously, guide brackets can also be arranged in the vessel receiving area 4, which acts against the vessel 3 as leaf springs, for example, and which position and fix the vessel 3, according to this embodiment. As a result, the insertion of the vessel 3 into the housing 2 is facilitated as well.

Finally, FIGS. 49 to 53 show a seventh embodiment of the invention. According to this embodiment alternative, the vessel 3 and the vessel receiving area 4 of the kitchen appliance 1 have corresponding electric contacts 31, 32, 33, 34 for establishing an electric connection between the kitchen appliance 1 and the vessel 3. As is shown in FIG. 51, the electric contacts 31, 32 of the vessel receiving area 4 are in each case embodied in the shape of a pitch circle. The electric contacts 31, 32 run parallel to one another and have a gap area between one another, into which the electric contacts 33, 34 of the vessel 3 can be inserted. As is illustrated in FIG. 52, the electric contacts 33, 34 of the vessel 3 are embodied as pins, for example, here in particular five pins, which can be displaced between the electric contacts 31, 32 of the vessel receiving area 4.

The positioning of the electric contacts 31, 32, 33, 34 to one another is illustrated, for example by means of the embodiment of the kitchen appliance 1 according to FIGS. 1 to 7. However, it is also possible to position the contacts 31, 32, 33, 34 according to the invention in accordance with the further embodiments described previously.

The electric contacts 33, 34 of the vessel 3 can be received continuously between the electric contacts 31, 32 of the vessel receiving area 4 in circumferential direction, so that an electric connection between the vessel 3 and the vessel receiving are 4 can also be established in response to different rotational positions of the vessel 3 inside the vessel receiving area 4. It is only required for the electric contacts 33, 34 of the vessel 3 to be received completely between the electric contacts 31, 32 of the vessel receiving area 4. The angular range, which the electric contacts 31, 32 of the vessel receiving area 4 span, specifies the area of a possible contact position to the electric contacts 33, 34 of the vessel 3 in this regard.

If a user wants to insert the vessel 3 into the vessel receiving area 4 of the kitchen appliance 1 (FIG. 49), he pivots the two wings 8 of the closing device 7 about the respective vertical axes of rotation 24 until the jacket recess 6 is open completely. The user then inserts the vessel 3 into the vessel receiving area 4, advantageously from a horizontal direction. As a result of the subsequent pivoting of the wings 8 in the direction of the jacket recess 6, the hand grip element 10, here a handle, of the vessel 3, glides along the inner wall of one of the wings 8. As a result of the shape-corresponding embodiment of the inner wall of the wing 8 and of the outer wall of the vessel 3 or of the hand grip element 10, respectively, the hand grip element 10 finally reaches into the gap 9, which remains free between the wings 8. In this orientation, the vessel 3 is oriented to the housing 2 of the kitchen appliance 1 in such a manner that the electric contacts 33, 34 of the vessel 3 contact the electric contacts 31, 32 of the vessel receiving area 4. An electric connection can now be established between the vessel 3 and the kitchen appliance 1.

Regardless of the embodiment alternatives illustrated here, it goes without saying that subcombinations between features of the individual embodiment alternatives are also possible in the context of the invention. For example, the embodiments of the vessel 3, of the vessel receiving area 4, of the lid 5, of the closing device 7, of the locking element 13, of the lifting device 14, of the locking bracket 37, etc. can be combined with one another, insofar as this is sensible in terms of the invention.

### LIST OF REFERENCE NUMERALS

1 kitchen appliance

2 housing

3 vessel

4 vessel receiving area

5 lid

6 jacket recess

7 closing device

8 wing

9 gap

10 hand grip element

11 sliding element

12 recess

13 locking element

14 lifting device

15 bottom area

16 lifting platform

17 engagement element

18 guide

19 lifting element

20 ramp

21 locking appendage

22 lid lug

23 additional element

24 vertical axis of rotation

25 horizontal axis of rotation

26 axis

27 vessel guide

28 housing guide

29 spring element

30 bracket appendage

31 electric contact

32 electric contact

33 electric contact

34 electric contact

35 engagement area

36 axis

37 locking bracket

1. A kitchen appliance (1), in particular a mixer, comprising a housing (2), on which a vessel (3) can be arranged, wherein the housing (2) has a vessel receiving area (4), into which the vessel (3) can be inserted, wherein the vessel receiving area (4) is embodied so as to correspond to the shape of the vessel (3) at least in a partial area in such a manner that the vessel (3) can be oriented with regard to a vertical direction as well as with regard to a circumferential direction of the vessel (3) in the course of the insertion into the vessel receiving area (4), wherein the vessel receiving area (4) is substantially embodied as a cylinder, the cylinder jacket of which has a jacket recess (6), so that the cylinder is embodied so as to be substantially open on one side in circumferential direction, wherein a closing device (7), which has at least one pivotable wing (8) or at least one sliding element (11), which can be shifted in circumferential direction, is arranged on the housing (2), wherein the pivotable wing (8) can be pivoted into the jacket recess (6) so as to correspond to the shape thereof, or wherein the sliding element (11) can be slid into the jacket recess (6) so as to correspond to the shape thereof.

2. The kitchen appliance (1) according to claim 1, wherein the closing device (7) has a wing (8), which can be pivoted about a vertical axis of rotation (24) or two wings (8), which can in each case be pivoted about a vertical axis of rotation (24).

3. The kitchen appliance (1) according to claim 2, wherein with regard to a state of the wing (8), in which it is pivoted into the jacket recess (6), a gap (9) is embodied between the wing (8) and the vessel receiving area (4) or between two wings (8), in which gap (9) a partial area, in particular a hand grip element (10) of the vessel (3), can be arranged.

4. The kitchen appliance (1) according to claim 1, wherein with regard to a state of the sliding element (11), in which it is slid into the jacket recess (6), a gap (9) is embodied between the sliding element (11) and the vessel receiving area (4) or between two sliding elements (11), in which gap (9) a partial area, in particular a hand grip element (10) of the vessel (3), can be arranged.

5. The kitchen appliance (1) according to claim 1, wherein the closing device (7) has a wing (8), which can be pivoted about a horizontal axis of rotation (25).

6. The kitchen appliance (1) according to claim 5, wherein the wing (8) has a recess (12), in which a partial area, in particular a hand grip element (10) of the vessel (3), can be arranged.

7. The kitchen appliance (1) according to claim 1, wherein the closing device (7) is in operative connection with a lifting device (14) or has a lifting device (14), which is embodied to lift a vessel (3), which is inserted into the vessel receiving (4) area, in response to the actuation of the closing device (7) opposite an insertion direction and/or to lower a vessel (3), which is to be inserted into the vessel receiving area (4), in insertion direction.

8. The kitchen appliance (1) according to claim 7, wherein the lifting device (14) has a lifting platform (16), which is arranged in a bottom area (15) of the vessel receiving area (4), which lifting platform (16) has an engagement element (17), which engages with a thread-like guide (18) of the closing device (7).

9. The kitchen appliance (1) according to claim 7, wherein the closing device (7) has a lifting element (19), which is in operative connection with a ramp (20), which is embodied on the housing (3), in such a manner that the lifting element (19) can be moved along the ramp (20) in response to an actuation of the closing device (7).

10. The kitchen appliance (1) according to claim 1, wherein the closing device (7) is in operative connection with a locking device for locking the vessel (3) by means of a lid (5) or is part of a locking device, in particular has locking elements (13) for arrangement on the lid (5).

11. A kitchen appliance (1), in particular a mixer, comprising a housing (2), on which a vessel (3) can be arranged, wherein the housing (2) has a vessel receiving area (4), into which the vessel (3) can be inserted, wherein the vessel receiving area (4) is embodied so as to correspond to the shape of the vessel (3) at least in a partial area in such a manner that the vessel (3) can be oriented with regard to a vertical direction as well as with regard to a circumferential direction of the vessel (3) in the course of the insertion into the vessel receiving area (4), wherein the vessel receiving area (4) is substantially embodied as a cylinder, the cylinder jacket of which has a jacket recess (6), so that the cylinder is embodied so as to be substantially open on one side in circumferential direction, wherein the vessel (3) has a partial engagement area (35), which is embodied so as to correspond to the shape of the jacket recess (6) and which has a larger material thickness than the other partial areas of the vessel (3) in circumferential direction, wherein the partial engagement area (35) closes the jacket recess (6) in the inserted state of the vessel (3).

12. The kitchen appliance (1) according to claim 11, comprising a locking device for locking the vessel (3) by means of a lid (5), wherein the locking device has a locking bracket (21), which is arranged on the housing (2) and which can be pivoted about a horizontal axis (26) and which, in the locked state, contacts a partial area of the lid (5).

13. The kitchen appliance (1) according to claim 1, wherein the vessel (3) and the vessel receiving area (4) have electric contacts (31, 32, 33, 34) for establishing an electric connection between the vessel (3) and the kitchen appliance (1), wherein, in the course of being inserted into the vessel receiving area (4), the vessel (3) can be oriented relative to the housing (2) in such a manner that the electric contacts (31, 32) of the vessel (3) and the electric contacts (33, 34) of the vessel receiving area (4) contact one another.
